(19) United States
(12) Patent Application Publication
(10) Pub. No.: US 2023/0247655 A1
(43) Pub. Date: Aug. 3, 2023

(54) TECHNIQUES FOR COMMUNICATING EXPECTED DATA INDICATION FOR NETWORK POWER SAVINGS

(71) Applicant: QUALCOMM Incorporated, San Diego, CA (US)

(72) Inventors: Hung Dinh Ly, San Diego, CA (US); Linhai He, San Diego, CA (US); Yongjun Kwak, San Diego, CA (US)

(21) Appl. No.: 17/587,857

(22) Filed: Jan. 28, 2022

(51) Int. Cl. H04W 72/12; H04W 24/08

(52) U.S. Cl. CPC H04W 72/1252; H04W 72/1268; H04W 72/1284; H04W 24/08

(57) ABSTRACT

Methods, systems, and devices for wireless communications are described. A user equipment (UE) may be configured to receive, from a base station, control signaling indicating a proactive traffic reporting configuration identifying a trigger condition for proactively reporting expected data traffic for the UE. The UE may transmit, to the base station based on a satisfaction of the trigger condition, an uplink message including an indication of an expected amount of data traffic for the UE, where the satisfaction of the trigger condition is based on the expected amount of data traffic. The UE may subsequently receive, in response to the uplink message, a downlink message indicating a resource allocated for communicating the expected amount of data traffic, and may communicate at least a portion of the expected amount of data traffic with the base station via the indicated resource.

### FIELD OF TECHNOLOGY

The following relates to wireless communications, including techniques for communicating expected data indication for network power savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In order to manage resource allocations in some wireless communications systems, the network (e.g., base stations) may monitor data traffic within the system for some time period, and may selectively allocate carriers and other resources for wireless communications based on the monitoring. However, there may be some delay or lag time between data traffic observed by the network, and communication resources allocated based on the observed data traffic. This may result in inefficiency, as such lag may result in the network allocating too many (or too few) communications resources relative to the traffic experienced within the wireless communications system.

### SUMMARY

The described techniques relate to improved methods, systems, devices, and apparatuses that support techniques for communicating expected data indication for network power savings. Generally, the described techniques provide for signaling and other configurations which enable user equipments (UEs) to proactively indicate data traffic which is expected at the UE at some point in the future. In this regard, aspects of the present disclosure may enable UEs to proactively indicate uplink and downlink data traffic which is anticipated in the future, which may enable the network to proactively and dynamically estimate traffic loads within the system in advance, which may improve allocations of communications resources. For example, a UE receives a proactive traffic reporting configuration which includes trigger conditions for proactively reporting expected data traffic at the UE. In this example, the UE identifies a satisfaction of a trigger condition based on an amount of data traffic expected at the UE, and transmits a message (e.g., proactive buffer status report (BSR)) which indicates the amount of expected data traffic. Subsequently, the UE receives a resource allocation for the amount of expected data traffic, and communicates the expected data traffic on the allocated resources.

A method is described. The method may include receiving, from a base station, control signaling indicating a proactive traffic reporting configuration identifying a trigger condition for proactively reporting expected data traffic for the UE, transmitting, to the base station based on a satisfaction of the trigger condition, an uplink message including an indication of an expected amount of data traffic for the UE, where the satisfaction of the trigger condition is based on the expected amount of data traffic, receiving, in response to the uplink message, a downlink message indicating a resource allocated for communicating the expected amount of data traffic, and communicating at least a portion of the expected amount of data traffic with the base station via the indicated resource.

An apparatus is described. The apparatus may include a processor, memory coupled with the processor, and instructions stored in the memory. The instructions may be executable by the processor to cause the apparatus to receive, from a base station, control signaling indicating a proactive traffic reporting configuration identifying a trigger condition for proactively reporting expected data traffic for the UE, transmit, to the base station based on a satisfaction of the trigger condition, an uplink message including an indication of an expected amount of data traffic for the UE, where the satisfaction of the trigger condition is based on the expected amount of data traffic, receive, in response to the uplink message, a downlink message indicating a resource allocated for communicating the expected amount of data traffic, and communicate at least a portion of the expected amount of data traffic with the base station via the indicated resource.

Another apparatus is described. The apparatus may include means for receiving, from a base station, control signaling indicating a proactive traffic reporting configuration identifying a trigger condition for proactively reporting expected data traffic for the UE, means for transmitting, to the base station based on a satisfaction of the trigger condition, an uplink message including an indication of an expected amount of data traffic for the UE, where the satisfaction of the trigger condition is based on the expected amount of data traffic, means for receiving, in response to the uplink message, a downlink message indicating a resource allocated for communicating the expected amount of data traffic, and means for communicating at least a portion of the expected amount of data traffic with the base station via the indicated resource.

A non-transitory computer-readable medium storing code is described. The code may include instructions executable by a processor to receive, from a base station, control signaling indicating a proactive traffic reporting configuration identifying a trigger condition for proactively reporting expected data traffic for the UE, transmit, to the base station based on a satisfaction of the trigger condition, an uplink message including an indication of an expected amount of data traffic for the UE, where the satisfaction of the trigger condition is based on the expected amount of data traffic, receive, in response to the uplink message, a downlink message indicating a resource allocated for communicating the expected amount of data traffic, and communicate at least a portion of the expected amount of data traffic with the base station via the indicated resource.

Some examples of the method, apparatuses, and non-transitory computer-readable medium described herein may further include operations, features, means, or instructions for transmitting, to the base station and based on transmitting the uplink message, a second uplink message including an indication of a scheduled amount of data traffic for the UE, a buffered amount of data traffic for the UE, or both, where receiving the downlink message, communicating at least the portion of the expected amount of data traffic, or both, may be based on the second uplink message.

Some examples of the method, apparatuses, and non-transitory computer-readable medium described herein may further include operations, features, means, or instructions for transmitting, via the second uplink message, an indication of a first difference between the expected amount of data traffic and the scheduled amount of data traffic, a second difference between the expected amount of data traffic and the buffered amount of data traffic, or both, where receiving the downlink message, communicating at least the portion of the expected amount of data traffic, or both, may be based on the first difference, the second difference, or both.

Some examples of the method, apparatuses, and non-transitory computer-readable medium described herein may further include operations, features, means, or instructions for receiving, via the control signaling, an indication of a data threshold associated with the trigger condition for proactively reporting expected data traffic, where the satisfaction of the trigger condition may be based on the expected amount of data traffic being greater than or equal to the data threshold.

Some examples of the method, apparatuses, and non-transitory computer-readable medium described herein may further include operations, features, means, or instructions for receiving, via the control signaling, an indication of a time threshold associated with the trigger condition for proactively reporting expected data traffic, where the satisfaction of the trigger condition may be based on the expected amount of data traffic being expected within the time threshold.

Some examples of the method, apparatuses, and non-transitory computer-readable medium described herein may further include operations, features, means, or instructions for receiving, via the control signaling, an activation of the proactive traffic reporting configuration, where transmitting the uplink message may be based on the activation of the proactive traffic reporting configuration.

Some examples of the method, apparatuses, and non-transitory computer-readable medium described herein may further include operations, features, means, or instructions for transmitting, via the uplink message, an expected time resource associated with the expected amount of data traffic, where the resource allocated for communicating the expected amount of data traffic may be based on the expected time resource.

Some examples of the method, apparatuses, and non-transitory computer-readable medium described herein may further include operations, features, means, or instructions for transmitting, to the base station, a second uplink message including an indication of a second expected amount of data traffic for the UE, an indication of a change in the expected amount of data traffic for the UE, or both, where receiving the downlink message, communicating the portion of the expected amount of data traffic, or both, may be based on the second uplink message.

Some examples of the method, apparatuses, and non-transitory computer-readable medium described herein may further include operations, features, means, or instructions for transmitting a scheduling request to the base station based on the satisfaction of the trigger condition and receiving, from the base station in response to the scheduling request, an indication of a second resource for communicating the uplink message, where the uplink message may be transmitted within the second resource.

Some examples of the method, apparatuses, and non-transitory computer-readable medium described herein may further include operations, features, means, or instructions for receiving, via the downlink message, an indication of an activated communications resource that may have been activated in response to the expected amount of data traffic, where the portion of the expected amount of data traffic may be communicated within the activated communications resource, and where the activated communications resource includes an activated component carrier, an activated bandwidth part, an activated serving cell supported by the base station, or any combination thereof.

Some examples of the method, apparatuses, and non-transitory computer-readable medium described herein may further include operations, features, means, or instructions for receiving, via the downlink message, an indication to selectively adjust a quantity of communication layers used for communications at the UE, an indication to selectively adjust a hybrid automatic repeat request (HARQ) process, or both, where communicating the portion of the expected amount of data traffic may be based on the indication to selectively adjust a quantity of communication layers used for communications at the UE, the indication to selectively adjust the HARQ process, or both.

In some examples of the method, apparatuses, and non-transitory computer-readable medium described herein, the expected amount of data traffic includes an expected amount of uplink data traffic for the UE and the uplink message includes a BSR message, a medium access control-control element (MAC-CE) message, or both.

In some examples of the method, apparatuses, and non-transitory computer-readable medium described herein, the expected amount of data traffic may be indicated via one or more logical channel identifier (LCID) fields within the BSR message, within the MAC-CE message, or both and the one or more LCID fields may be associated with proactively reporting expected data traffic for the UE.

In some examples of the method, apparatuses, and non-transitory computer-readable medium described herein, the expected amount of data traffic includes an expected amount of downlink data traffic for the UE and the uplink message includes a message of a random access procedure, a UE assistance information message, or both.

In some examples of the method, apparatuses, and non-transitory computer-readable medium described herein, the expected amount of data traffic includes an amount of data traffic which may have not yet been scheduled for the UE, buffered by the UE, or both.

A method is described. The method may include transmitting, to a UE, control signaling indicating a proactive traffic reporting configuration identifying a trigger condition for proactively reporting expected data traffic for the UE, receiving, from the UE based on a satisfaction of the trigger condition, an uplink message including an indication of an expected amount of data traffic for the UE, where the satisfaction of the trigger condition is based on the expected amount of data traffic, transmitting, in response to the uplink message, a downlink message indicating a resource allocated for communicating the expected amount of data traffic, and communicating at least a portion of the expected amount of data traffic with the UE via the indicated resource.

An apparatus is described. The apparatus may include a processor, memory coupled with the processor, and instructions stored in the memory. The instructions may be executable by the processor to cause the apparatus to transmit, to a UE, control signaling indicating a proactive traffic reporting configuration identifying a trigger condition for proactively reporting expected data traffic for the UE, receive, from the UE based on a satisfaction of the trigger condition, an uplink message including an indication of an expected amount of data traffic for the UE, where the satisfaction of the trigger condition is based on the expected amount of data traffic, transmit, in response to the uplink message, a downlink message indicating a resource allocated for communicating the expected amount of data traffic, and communicate at least a portion of the expected amount of data traffic with the UE via the indicated resource.

Another apparatus is described. The apparatus may include means for transmitting, to a UE, control signaling indicating a proactive traffic reporting configuration identifying a trigger condition for proactively reporting expected data traffic for the UE, means for receiving, from the UE based on a satisfaction of the trigger condition, an uplink message including an indication of an expected amount of data traffic for the UE, where the satisfaction of the trigger condition is based on the expected amount of data traffic, means for transmitting, in response to the uplink message, a downlink message indicating a resource allocated for communicating the expected amount of data traffic, and means for communicating at least a portion of the expected amount of data traffic with the UE via the indicated resource.

A non-transitory computer-readable medium storing code is described. The code may include instructions executable by a processor to transmit, to a UE, control signaling indicating a proactive traffic reporting configuration identifying a trigger condition for proactively reporting expected data traffic for the UE, receive, from the UE based on a satisfaction of the trigger condition, an uplink message including an indication of an expected amount of data traffic for the UE, where the satisfaction of the trigger condition is based on the expected amount of data traffic, transmit, in response to the uplink message, a downlink message indicating a resource allocated for communicating the expected amount of data traffic, and communicate at least a portion of the expected amount of data traffic with the UE via the indicated resource.

Some examples of the method, apparatuses, and non-transitory computer-readable medium described herein may further include operations, features, means, or instructions for receiving, from the UE and based on transmitting the uplink message, a second uplink message including an indication of a scheduled amount of data traffic for the UE, a buffered amount of data traffic for the UE, or both, where transmitting the downlink message, communicating at least the portion of the expected amount of data traffic, or both, may be based on the second uplink message.

Some examples of the method, apparatuses, and non-transitory computer-readable medium described herein may further include operations, features, means, or instructions for receiving, via the second uplink message, an indication of a first difference between the expected amount of data traffic and the scheduled amount of data traffic, a second difference between the expected amount of data traffic and the buffered amount of data traffic, or both, where transmitting the downlink message, communicating at least the portion of the expected amount of data traffic, or both, may be based on the first difference, the second difference, or both.

Some examples of the method, apparatuses, and non-transitory computer-readable medium described herein may further include operations, features, means, or instructions for transmitting, to the UE based on the first difference, the second difference, or both, a second downlink message indicating a deactivation of the proactive traffic reporting configuration.

Some examples of the method, apparatuses, and non-transitory computer-readable medium described herein may further include operations, features, means, or instructions for transmitting, via the control signaling, an indication of a data threshold associated with the trigger condition for proactively reporting expected data traffic, where the satisfaction of the trigger condition may be based on the expected amount of data traffic being greater than or equal to the data threshold.

Some examples of the method, apparatuses, and non-transitory computer-readable medium described herein may further include operations, features, means, or instructions for transmitting, via the control signaling, an indication of a time threshold associated with the trigger condition for proactively reporting expected data traffic, where the satisfaction of the trigger condition may be based on the expected amount of data traffic being expected within the time threshold.

Some examples of the method, apparatuses, and non-transitory computer-readable medium described herein may further include operations, features, means, or instructions for transmitting, via the control signaling, an activation of the proactive traffic reporting configuration, where receiving the uplink message may be based on the activation of the proactive traffic reporting configuration.

Some examples of the method, apparatuses, and non-transitory computer-readable medium described herein may further include operations, features, means, or instructions for transmitting, via the control signaling, the activation of the proactive traffic reporting configuration based on an amount of data traffic for the base station satisfying a data traffic threshold.

Some examples of the method, apparatuses, and non-transitory computer-readable medium described herein may further include operations, features, means, or instructions for transmitting, to the UE, a second downlink message including a deactivation of the proactive traffic reporting configuration based on an amount of data traffic for the base station failing to satisfy a data traffic threshold.

Some examples of the method, apparatuses, and non-transitory computer-readable medium described herein may further include operations, features, means, or instructions for receiving, via the uplink message, an expected time resource associated with the expected amount of data traffic, where the resource allocated for communicating the expected amount of data traffic may be based on the expected time resource.

Some examples of the method, apparatuses, and non-transitory computer-readable medium described herein may further include operations, features, means, or instructions for receiving, from the UE, a second uplink message including an indication of a second expected amount of data traffic for the UE, an indication of a change in the expected amount of data traffic for the UE, or both, where transmitting the downlink message, communicating the portion of the expected amount of data traffic, or both, may be based on the second uplink message.

Some examples of the method, apparatuses, and non-transitory computer-readable medium described herein may further include operations, features, means, or instructions for receiving a scheduling request to the base station based on the satisfaction of the trigger condition and transmitting, to the UE in response to the scheduling request, an indication of a second resource for communicating the uplink message, where the uplink message may be received within the second resource.

Some examples of the method, apparatuses, and non-transitory computer-readable medium described herein may further include operations, features, means, or instructions for transmitting, via the downlink message, an indication of an activated communications resource that may have been activated in response to the expected amount of data traffic, where the portion of the expected amount of data traffic may be communicated within the activated communications resource, and where the activated communications resource includes an activated component carrier, an activated bandwidth part, an activated serving cell supported by the base station, or any combination thereof.

Some examples of the method, apparatuses, and non-transitory computer-readable medium described herein may further include operations, features, means, or instructions for transmitting, via the downlink message, an indication to selectively adjust a quantity of communication layers used for communications at the UE, an indication to selectively adjust a HARQ process, or both, where communicating the portion of the expected amount of data traffic may be based on the indication to selectively adjust a quantity of communication layers used for communications at the UE, the indication to selectively adjust the HARQ process, or both.

In some examples of the method, apparatuses, and non-transitory computer-readable medium described herein, the expected amount of data traffic includes an expected amount of uplink data traffic for the UE and the uplink message includes a BSR message, a MAC-CE message, or both.

In some examples of the method, apparatuses, and non-transitory computer-readable medium described herein, the expected amount of data traffic may be indicated via one or more LCD fields within the BSR message, within the MAC-CE message, or both and the one or more LCD fields may be associated with proactively reporting expected data traffic for the UE.

In some examples of the method, apparatuses, and non-transitory computer-readable medium described herein, the expected amount of data traffic includes an expected amount of downlink data traffic for the UE and the uplink message includes a message of a random access procedure, a UE assistance information message, or both.

In some examples of the method, apparatuses, and non-transitory computer-readable medium described herein, the expected amount of data traffic includes an amount of data traffic which may have not yet been scheduled for the UE, buffered by the UE, or both.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports techniques for communicating expected data indication for network power savings in accordance with aspects of the present disclosure.

FIG. 2 illustrates an example of a wireless communications system that supports techniques for communicating expected data indication for network power savings in accordance with aspects of the present disclosure.

FIG. 3 illustrates an example of a process flow that supports techniques for communicating expected data indication for network power savings in accordance with aspects of the present disclosure.

FIGS. 4 and 5 show block diagrams of devices that support techniques for communicating expected data indication for network power savings in accordance with aspects of the present disclosure.

FIG. 6 shows a block diagram of a communications manager that supports techniques for communicating expected data indication for network power savings in accordance with aspects of the present disclosure.

FIG. 7 shows a diagram of a system including a device that supports techniques for communicating expected data indication for network power savings in accordance with aspects of the present disclosure.

FIGS. 8 and 9 show block diagrams of devices that support techniques for communicating expected data indication for network power savings in accordance with aspects of the present disclosure.

FIG. 10 shows a block diagram of a communications manager that supports techniques for communicating expected data indication for network power savings in accordance with aspects of the present disclosure.

FIG. 11 shows a diagram of a system including a device that supports techniques for communicating expected data indication for network power savings in accordance with aspects of the present disclosure.

FIGS. 12 through 15 show flowcharts illustrating methods that support techniques for communicating expected data indication for network power savings in accordance with aspects of the present disclosure.

### DETAILED DESCRIPTION

In order to manage resource allocations in some wireless communications systems, the network (e.g., base stations) may monitor data traffic within the system for some time period, and may selectively allocate carriers and other resources for wireless communications based on the monitoring. Additionally, upon buffering/scheduling data traffic, user equipments (UEs) may transmit buffer status reports (BSRs) which indicate buffered/scheduled data traffic. As such, wireless communications systems may reactively allocate communications resources based on data traffic within the wireless communications system, and based on BSRs received from UEs. However, there may be some delay or lag time between data traffic observed by the network, and communication resources allocated based on the observed data traffic. This may result in inefficiency, as such lag may result in the network allocating too many (or too few) communications resources relative to the traffic experienced within the wireless communications system.

Moreover, base stations consume large quantities of power, particularly in the context of 5G communications systems, where the power consumption at the base stations is based on allocated communications resources. In particular, larger bandwidths, increased quantities of carriers, and increased quantities of antennas and bands may increase power consumption at the base station. As such, in cases where the network allocates larger quantities of communications resources than are required by the system, the energy consumption of the network may be unnecessarily increased. Aspects of the disclosure are initially described in the context of wireless communications systems.

Accordingly, aspects of the present disclosure are directed to signaling and other configurations which enable UEs to proactively indicate data traffic which is expected at the UE at some point in the future. In this regard, aspects of the present disclosure support techniques which enable UEs to proactively indicate uplink and downlink data traffic which is anticipated in the future, which may enable the network to proactively and dynamically estimate traffic loads within the system in advance, which may improve allocations of communications resources. For example, a UE receives a proactive traffic reporting configuration which includes trigger conditions for proactively reporting expected data traffic at the UE. In this example, the UE identifies a satisfaction of a trigger condition based on an amount of data traffic expected at the UE, and transmits a message (e.g., “proactive BSR”) which indicates the amount of expected data traffic. Subsequently, the UE receives a resource allocation for the amount of expected data traffic, and communicates the expected data traffic on the allocated resources.

In some cases, proactive BSR reporting may be combined with legacy, reactive BSR reporting. For example, the UE may transmit the proactive BSR report indicating expected data traffic (1st stage), and may subsequently transmit a legacy BSR report which indicates the actual buffered traffic (2nd stage). The second stage BSR report may indicate a difference between the expected and actual data traffic at the UE. In some cases, the network may enable/disable proactive data traffic reporting, such as based on the traffic load within the system (e.g., with low traffic load, proactive reporting may not be necessary).

Aspects of the disclosure are further illustrated by and described with reference to apparatus diagrams, system diagrams, and flowcharts that relate to techniques for communicating expected data indication for network power savings.

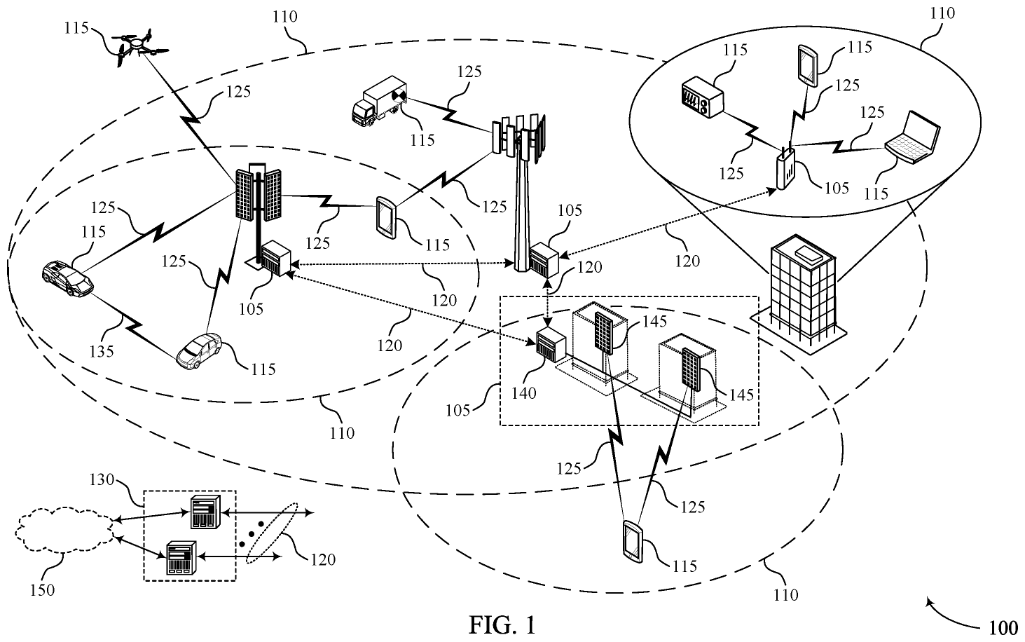

FIG. 1 illustrates an example of a wireless communications system 100 that supports techniques for communicating expected data indication for network power savings in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Δf_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless devices (e.g., UEs 115, base stations 105) of the wireless communications system 100 may be configured to support signaling and other configurations which enable UEs 115 and other wireless devices (e.g., IAB nodes) to proactively indicate data traffic which is expected at the UE 115 or other wireless device at some point in the future. In this regard, the wireless communications system 100 may support techniques which enable UEs 115 to proactively indicate uplink and downlink data traffic which is anticipated in the future, which may enable the network to proactively and dynamically estimate traffic loads within the system in advance, which may improve allocations of communications resources.

For example, a UE 115 of the wireless communications system 100 may receive a proactive traffic reporting configuration which includes trigger conditions for proactively reporting expected data traffic at the UE 115. In this example, the UE 115 may identify a satisfaction of a trigger condition based on an amount of data traffic expected at the UE 115, and may transmit a message (e.g., proactive BSR) which indicates the amount of expected data traffic. Subsequently, the UE 115 may receive a resource allocation for the amount of expected data traffic, and may communicate the expected data traffic on the allocated resources.

In some cases, proactive BSR reporting may be combined with legacy, reactive BSR reporting. For example, the UE 115 may transmit the proactive BSR report indicating expected data traffic (1st stage), and may subsequently transmit a legacy BSR report which indicates the actual buffered traffic (2nd stage). The second stage BSR report may indicate a difference between the expected and actual data traffic at the UE. In some cases, the network may enable/disable proactive data traffic reporting, such as based on the traffic load within the system (e.g., with low traffic load, proactive reporting may not be necessary).

Techniques described herein may enable UEs 115 to proactively report expected uplink and downlink traffic which is expected at the UEs 115, which may enable the network to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

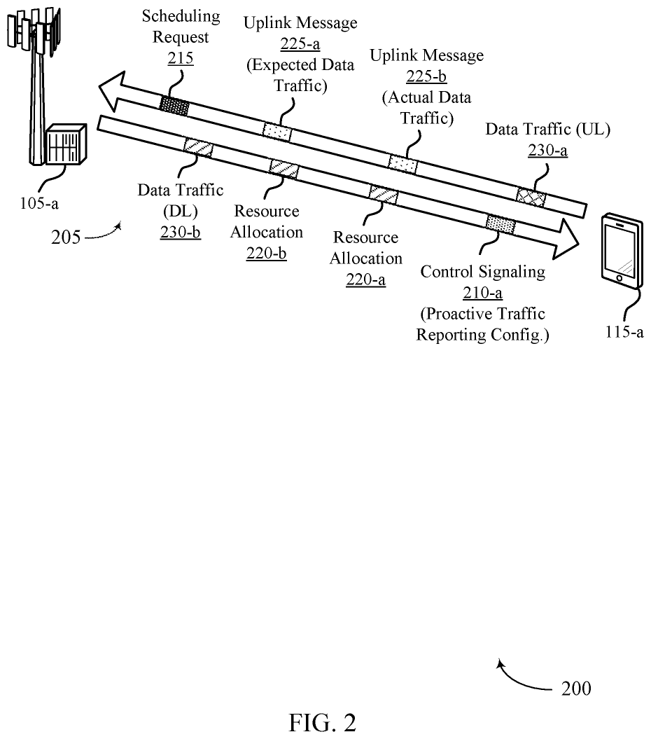

FIG. 2 illustrates an example of a wireless communications system 200 that supports techniques for communicating expected data indication for network power savings in accordance with aspects of the present disclosure. In some examples, wireless communications system 200 may implement, or be implemented by, aspects of wireless communications system 100. The wireless communications system 200 may include a base station 105-a and a UE 115-a, which may be examples of base stations 105 and UEs 115 described herein with reference to FIG. 1.

The UE 115-a may communicate with the base station 105-a using one or more communication links 205. For example, the UE 115-a may communicate with the base station 105-a via a communication link 205, which may include an example of an access link (e.g., Uu link). The communication link 205 may include a bi-directional link that can include both uplink and downlink communication. For example, the UE 115-a may transmit uplink transmissions, such as uplink control signals or uplink data signals, to the base station 105-a via communication link 205, and the base station 105-a may transmit downlink transmissions, such as downlink control signals or downlink data signals, to the UE 115-a via the communication link 205.

As noted previously herein, in order to manage resource allocations in some wireless communications systems, the network (e.g., base stations 105) may monitor data traffic within the system for some time period, and may selectively allocate carriers and other resources for wireless communications based on the monitoring. Additionally, upon buffering/scheduling data traffic, UEs 115 may transmit BSRs which indicate buffered/scheduled data traffic at the respective UEs 115. Conventional BSR messages may be considered to be “reactive” in that a UE 115 does not transmit a BSR until the UE 115 has actual, buffered data to be transmitted. As such, wireless communications systems may reactively allocate communications resources based on data traffic within the wireless communications system, and based on BSRs received from UEs 115. However, there may be some delay or lag time between data traffic observed by the network, and communication resources allocated based on the observed data traffic. This may result in inefficiency, as such lag may result in the network allocating too many (or too few) communications resources relative to the traffic experienced within the wireless communications system.

Moreover, base stations consume large quantities of power, particularly in the context of 5G communications systems, where the power consumption at the base stations is based on allocated communications resources. In particular, larger bandwidths, increased quantities of carriers, and increased quantities of antennas and bands may increase power consumption at the base station. As such, in cases where the network allocates larger quantities of communications resources than are required by the system, the energy consumption of the network may be unnecessarily increased. Aspects of the disclosure are initially described in the context of wireless communications systems.

Accordingly, the UE 115-a and the base station 105-a of the wireless communications system 200 may support signaling and other configurations which enables the UE 115-a to “proactively” indicate data traffic which is expected at the UE 115-a at some point in the future. In particular, for some applications in which the UE 115-a may be able to predict data traffic before the data actually arrives (e.g., web browsing, downloading/uploading images or videos), the UE 115-b may transmit “proactive BSR” before the data actually arrives so that the network may better prepare for the transmission/reception adaptation.

In this regard, the wireless communications system 200 supports techniques which enables the UE 115-a to proactively indicate uplink and downlink data traffic which is anticipated in the future, which may enable the network (e.g., base station 105-a) to proactively and dynamically estimate traffic loads within the system in advance, which may improve allocations of communications resources. Techniques described herein may support more efficient dynamic and/or semi-static adaptation of wireless communications (with finer granularity) in one or more of time, frequency, spatial, and power domains. UEs 115 may be configured to support signaling/feedback mechanisms for reporting traffic characteristics for proactive traffic reporting. In particular, techniques described herein may provide the base station 105-a with early indications of changes in traffic loads within the wireless communications system 200, which may enable the base station 105-a to perform dynamic resource allocation/adaptation in time, frequency, space, and/or power domains, thereby improving power efficiency at the base station 105-a.

For example, the base station 105-a may monitor network traffic within the wireless communications system 200. That is, the base station 105-a may monitor quantities of uplink, downlink, and sidelink traffic within the wireless communications system 200, including scheduling requests 215 and indications of allocated resources. In particular, the base station 105-a may monitor an amount of network traffic which is scheduled (or expected) to be performed by the base station 105-a (e.g., scheduled/expected downlink/uplink traffic for the base station 105-a).

The base station 105-a may activate proactive traffic reporting within the wireless communications system 200. That is, the base station 105-a may activate, or otherwise enable, one or more proactive traffic reporting configurations which enable UEs 115 (e.g., UE 115-a) to proactively report expected data traffic 230 at the respective UEs 115. In some implementations, the base station 105-a may activate/enable proactive traffic reporting based on monitoring the network traffic within the wireless communications system 200.

For example, in some implementations, the base station 105-a may activate/enable proactive traffic reporting if an amount of network traffic monitored/observed within the wireless communications system 200 satisfies (e.g., exceeds) some traffic threshold. In some aspects, the base station 105-a may activate proactive traffic reporting (e.g., activate proactive traffic reporting configurations) in high-traffic conditions in order to enable the base station 105-a to receive early indications of changes in traffic load. Such early indications of expected traffic may enable the base station 105-a to be more aggressive when adapting short-term variations in traffic load (e.g., enable the base station 105-a to deactivate radio resources even when they are not needed temporarily). Comparatively, using legacy techniques in which the base station 105-a reactively adapts to changing traffic conditions (e.g., if data indications are reactive), the base station 105-a may have to be more conservative with managing radio resources in order to prevent under-allocating resources and degrading network performance.

In some aspects, the UE 115-a may receive, from the base station 105-a, control signaling 210-a indicating a proactive traffic reporting configuration for proactively reporting expected data traffic 230 for the UE 115-a. The base station 105-a may be configured to transmit the control signaling 210-a based on monitoring the network traffic within the wireless communications system 200, activating a proactive traffic reporting configuration, or both. For example, the control signaling 210-a may indicate that the proactive traffic reporting configuration has been activated for the UE 115-a. The control signaling 210-a indicating the proactive traffic reporting configuration may include an RRC message, a system information message, a MAC-CE, or any combination thereof.

In some aspects the proactive traffic reporting configuration may include (and/or indicate) one or more trigger conditions for proactively reporting expected data traffic 230 for the UE 115-a. In other words, the proactive traffic reporting configuration may include trigger conditions which enable the UE 115-b to autonomously trigger proactive BSR reporting. Trigger conditions may include any condition or metric at the UE 115-a, within the network, or both, that may be used to trigger proactive traffic reporting by the UE 115-a, including expected data thresholds, quality of service (QoS) requirements of expected data traffic 230, and the like. For example, a trigger condition may include a data threshold which, if satisfied, causes the UE 115-a to proactively report an expected amount of data traffic 230. For instance, the control signaling 210-a may indicate a data threshold associated with a trigger condition, where the UE 115-a may be configured to proactively report data traffic 230 if an expected amount of data traffic 230 at the UE 115-a is greater than or equal to the data threshold.

In some implementations, the control signaling 210-a may indicate how far in advance the UE 115-a is to predict or anticipate data traffic 230 for the purposes of proactive data reporting. That is, the base station 105-a may indicate that the UE 115-a is only to predict/anticipate data traffic 230 which is expected at the UE 115-a for some time threshold (e.g., 100-150 ms) in advance. Such time thresholds may prevent the UE 115-a from predicting expected data traffic 230 far in advance, which may result in inaccurate traffic predictions. In this regard, in some aspects, the control signaling 210-a may indicate a time threshold associated with the trigger condition for proactively reporting expected data traffic 230. In such cases, the UE 115-a may be configured to estimate/predict expected data traffic 230 which satisfies (e.g., falls within) the time threshold for the purposes of evaluating satisfaction of trigger conditions for proactive traffic reporting. In some cases, the time threshold may be pre-configured, dynamically adjusted and signaled by the base station 105-a (e.g., based on a quantity of network traffic), or both.

The UE 115-a may have more information regarding expected data traffic 230 at the UE 115-a compared to the base station 105-a, even in the context of downlink communications. In particular, some applications (e.g., web browsing, downloading/uploading images or videos) may enable the UE 115-a to predict amounts of data traffic 230 in advance, and report expected amounts of data traffic 230 to the network. Such proactive traffic reporting is not supported in some conventional wireless communications systems.

For example, a user of the UE 115-a may click on a video link (e.g., via a graphical user interface (GUI) of the UE 115-a) in order to download or stream a video. In this example, smart high-level operating system (HLOS) implementation (e.g., a connectivity engine in HLOS) executable by the UE 115-a may be configured to estimate the size of the video (e.g., based on past usage, information within the video link, etc.). Further, the UE 115-b may be configured to predict the downlink resource configuration (e.g., quantity of downlink resources, bandwidth configuration, secondary cell (SCell) configuration) which will be required to stream/download the video, and may be configured to compare the expected downlink resource configuration to determine whether the current downlink resource configuration (e.g., bandwidth or SCell configuration) will be able to sufficiently handle the streaming/download. In cases where the UE 115-a determines that the current downlink resource configuration will not be able to sufficiently handle the streaming/download, the UE 115-a may instruct for the lower layer to send a proactive traffic indication to network.

In this regard, the UE 115-a may identify a satisfaction of one or more trigger conditions associated with the proactive traffic reporting configuration based on the expected amount of data traffic 230. In this regard, the UE 115-a may identify that a trigger condition for proactive traffic reporting has been satisfied, and that the UE 115-a is to proactively report expected data traffic 230 to the base station 105-a. In some aspects, the satisfaction of the trigger condition may be based on an expected amount of data traffic 230 at the UE 115-a (e.g., expected amount of downlink, uplink, and/or sidelink traffic at the UE 115-a). The UE 115-a may identify the satisfaction of the trigger condition(s) in accordance with the proactive traffic reporting configuration indicated/configured via the control signaling 210-a.

For example, the UE 115-a may determine an expected amount of data traffic 230 which is to be transmitted and/or received by the UE 115-a at some time in the future. In this regard, the UE 115-a may identify an expected amount of data traffic 230 which has not yet been scheduled for the UE 115-a, buffered by the UE 115-a, or both. Moreover, the expected amount of data traffic 230 may include data traffic 230 which is expected within a time threshold associated with a trigger condition (e.g., data traffic 230 expected within the next 100 ms). In this example, the UE 115-a may identify that the expected amount of data traffic 230 is greater than or equal to a data threshold associated with a trigger condition for proactive traffic reporting, and may therefore identify that the trigger condition has been satisfied. Further, the UE 115-a may identify that the trigger condition has been satisfied based on the expected amount of data traffic 230 being expected within the respective time threshold (e.g., within the next 100 ms).

In some implementations, the UE 115-a may transmit a scheduling request 215 to the base station 105-a, where the scheduling request 215 includes a request for resources for proactively reporting expected data traffic 230 at the UE 115-a. In other words, the UE 115-a may transmit a scheduling request 215 for resources which will be used to transmit a proactive BSR message. The UE 115-a may transmit the scheduling request 215 based on receiving the control signaling 210-a, identifying the satisfaction of the trigger condition(s), or both. For example, in some aspects, the scheduling request 215 may include an indication that one or more trigger conditions for proactive traffic reporting have been satisfied at the UE 115-a.

The UE 115-a may receive a resource allocation 220-a from the base station 105-a. In some aspects, the UE 115-a may receive (and the base station 105-a may transmit) the resource allocation 220-a in response to the scheduling request 215. In this regard, the base station 105-a may schedule or allocate resources which will be used by the UE 115-a to transmit an indication of expected data traffic 230 at the UE 115-a (e.g., proactive BSR).

In some aspects, the UE 115-a may transmit, to the base station 105-a, a first uplink message 225-a including an indication of the expected amount of data traffic 230 for the UE 115-a. The first uplink message 225-a including the indication of the expected amount of data traffic 230 may be different from legacy BSR reporting in that the first uplink message 225-a reports expected amounts of data traffic 230 which are expected to come soon, rather than reports of actual data that has already been buffered by the UE 115-a.

In this regard, the UE 115-a may transmit the first uplink message 225-a indicating the expected amount of data traffic 230 based on receiving the control signaling 210-a for the proactive traffic reporting configuration, identifying the satisfaction of the trigger condition, transmitting the scheduling request 215, receiving the resource allocation 220-a, or any combination thereof. For example, the UE 115-a may transmit the first uplink message 225-a indicating the expected amount of data traffic 230 within the resource(s) which was indicated via the resource allocation 220-a, and based on the activation of the proactive traffic reporting configuration received via the control signaling 210-a.

The type of uplink message 225 (e.g., wake-up signal (WUS)) used to communicate the expected amount of data traffic 230 may be dependent upon the type of expected data traffic 230. Moreover, in some cases, the first uplink message 225-a may include a same or similar format as legacy BSR messages, and may include new/additional fields or indications which enable the base station 105-a to identify the first uplink message 225-a as an indication of proactive traffic reporting (e.g., identify the first uplink message 225-a as a proactive BSR message).

For example, in cases where the expected amount of data traffic 230 includes an expected amount of uplink data traffic 230-a for the UE 115-a (e.g., uplink data traffic 230-a expected to be transmitted by the UE 115-a at some time in the future), the first uplink message 225-a may include a BSR message, a MAC-CE message, or both. In such cases, the expected amount of uplink data traffic 230-a may be indicated via one or more logical channel identifier (LCID) fields associated with proactive traffic reporting within the BSR message and/or MAC-CE message. In other words, the first uplink message 225-a (e.g., proactive BSR message, MAC-CE message) may include dedicated fields (e.g., dedicated LCID fields) which are used to communicate indications of expected amounts of uplink data traffic 230-a.

By way of another example, in cases where the expected amount of data traffic 230 includes an expected amount of downlink data traffic 230-b for the UE 115-a (e.g., downlink data traffic 230-b expected to be received by the UE 115-a at some time in the future), the first uplink message 225-a may include a message of a random access procedure (e.g., random access channel (RACH) message), a UE assistance information message, or both. Further, the type of uplink message 225 used to communicate the expected amount of data traffic 230 may be dependent upon an operational mode in which the UE 115-a is operating (e.g., idle/inactive mode, connected mode). For instance, when the UE 115-a is in an idle/inactive mode of operation, the UE 115-a may communicate the expected amount of data traffic 230 via Msg3 or Msg5 of a RACH procedure. Comparatively, when the UE 115-a is in a connected mode of operation, the UE 115-a may communicate the expected amount of data traffic 230 via UE assistance information.

In some implementations, the first uplink message 225-a indicating the expected amount of data traffic 230 may further indicate when the expected amount of data traffic 230 is predicted/expected to be performed (e.g., when the expected data is expected to arrive at the UE 115-a, or expected to be transmitted by the UE 115-a). In other words, the UE 115-a may indicate an expected time resource associated with the expected amount of data traffic 230. In some cases, indications of expected time resources may be indicated via new, dedicated fields within the first uplink message 225-a (e.g., dedicated fields within a proactive BSR which are associated with proactive traffic reporting).

For instance, one or more fields within the first uplink message 225-a may indicate that the expected amount of data traffic 230 is expected to be transmitted/received in X slots (or other TTI) from the current slot/TTI. By indicating when the expected amount of data traffic 230 is expected to be transmitted/received, the base station 105-a may be able to more efficiently estimate/predict data traffic 230 within the wireless communications system 200, which may lead to more efficient use of resources and improved power consumption at the base station 105-a.

In some implementations, the UE 115-a may be configured to transmit multiple proactive BSR messages indicating expected amounts of data traffic 230. For example, the UE 115-a may transmit a first indication of a first expected amount of data traffic 230 expected to be performed at time T1, and may transmit a second indication of a second expected amount of data traffic 230 expected to be performed at time T2. In some cases, messages indicating expected amounts of data traffic 230 may additionally include updates to previously-reported amounts of expected data traffic 230.

In some aspects, the UE 115-a may transmit a second uplink message 225-b (e.g., BSR, MAC-CE, RACH message, UE assistance information message, UCI message) indicating a scheduled amount of data traffic 230 for the UE 115-a, a buffered amount of data traffic 230 for the UE 115-a, or both. In this regard, the first uplink message 225-a (e.g., first stage BSR) may indicate expected/predicted data traffic 230 for the UE 115-a, whereas the second uplink message 225-b (e.g., second stage BSR) indicates data traffic 230 which has been actually scheduled and/or buffered at the UE 115-a. In this regard, the UE 115-a may transmit the second uplink message 225-b based on (e.g., in response to) transmitting the first uplink message 225-a indicating the expected amount of data traffic 230.

In some aspects, the second uplink message 225-b may indicate amounts of scheduled/buffered data traffic 230 as a difference in data traffic 230 relative to the expected amount of data traffic 230 reported via the first uplink message 225-a. In other words, in some cases, the UE 115-a may report amounts of actual scheduled/buffered data traffic 230 as a delta (Δ) relative to the previously-reported expected amount of data traffic 230 (e.g., change in data traffic 230 with respect to the first stage). For example, in cases where the UE 115-a reports an expected amount of data traffic 230 (T_{Expected}), but is scheduled with (or buffers) a different amount of data traffic 230 (T_{Actual}), the second uplink message 225-b may indicate the scheduled/buffered data traffic 230 as the actual amount of scheduled/buffered data traffic 230 (e.g., indicate T_{Actual}), or may indicate the scheduled/buffered data traffic 230 as a difference relative to the expected data traffic 230 (e.g., indicate T_{Expected}−T_{Actual}=ΔT).

Upon receiving the uplink message(s) 225 indicating expected amounts of data traffic 230 and/or actually scheduled/buffered data traffic 230, it may be up to network implementation as to how (or whether) to act upon the received indications. That is, it may be up to the base station 105-a as to how the base station 105-a will respond to the indications of expected data traffic 230. Possible actions that may be performed by the base station 105-a in response to the indication of expected data traffic 230 may include, but are not limited to, activating additional serving cells (e.g., activate additional SCells), switching to a wider BWP, activating additional component carriers, adjust a quantity of communication layers at the UE 115-a (e.g., increase a quantity of downlink MIMO layers at the UE 115-a), adjust a HARQ process at the UE 115-a (e.g., configure more HARQ processes, reduce HARQ processing time, reduce k0 for PDSCH), or any combination thereof.

For example, the UE 115-a may receive a downlink message indicating a resource allocation 220-b for communicating at least a portion of the expected amount of data traffic 230. In other words, the base station 105-a may allocate resources which may be used by the UE 115-a to transmit/receive at least a portion of the expected amount of data traffic 230. In this regard, the UE 115-a may receive the downlink message including the resource allocation 220-b based on receiving the control signaling 210-a, identifying the satisfaction of the trigger condition(s), transmitting the scheduling request 215, receiving the resource allocation 220-a, transmitting the first uplink message 225-a indicating the expected amount of data traffic 230, transmitting the second uplink message 225-b indicating the actual scheduled/buffered amount of data traffic 230, or any combination thereof.

For example, in some cases, the base station 105-a may transmit the resource allocation 220-b to accommodate the entirety, or just a portion of, the expected amount of data traffic 230. In cases where the UE 115-a reports expected time resources for the expected amount of data traffic 230 (e.g., time resources in which the expected amount of data traffic 230 is to be performed), the base station 105-a may configure/transmit the resource allocation 220-b based on the expected time resources. Moreover, in some cases, the base station 105-a may transmit the resource allocation 220-b based on an indication of actually scheduled/buffered data traffic 230 indicated via the second uplink message 225-b. In this regard, the base station 105-a may allocate resources based on indicated differences between the expected data traffic 230 and the actually scheduled/buffered data traffic 230.

As noted previously herein, the base station 105-a may perform several actions that in response to the indication of expected data traffic 230 including, but not limited to, activating additional serving cells (e.g., activate additional SCells), switching to a wider BWP, activating additional component carriers, adjusting a quantity of communication layers at the UE 115-a, adjusting a HARQ process at the UE 115-a, or any combination thereof. In this regard, a downlink message including the resource allocation 220-b may additionally or alternatively indicate one or more actions that the base station 105-a has taken (or will take) in response to the expected amount of data traffic 230.

For example, in some cases, the base station 105-a may transmit an indication of an activated communications resource that has been activated in response to the expected amount of data traffic 230, where the activated communications resource includes an activated component carrier, an activated bandwidth part, an activated serving cell supported by the base station 105-a (e.g., activated SCell), or any combination thereof. By way of another example, base station 105-a may transmit an indication to selectively adjust a quantity of communication layers used for communications at the UE 115-a (e.g., increase a maximum quantity of downlink MIMO layers at the UE 115-a), an indication to selectively adjust a HARQ process at the UE 115-a, or both.

Subsequently, the UE 115-a may communicate at least a portion of the expected amount of data traffic 230. For example, the UE 115-a may transmit an expected amount of uplink data traffic 230-a, receive an expected amount of downlink data traffic 230-b, or both. In particular, the UE 115-a, the base station 105-a, or both, may communicate the expected data traffic 230 (which was reported via the first uplink message 225-a) in accordance with the proactive traffic reporting configuration. Moreover, the UE 115-a and the base station 105-a may communicate the expected amount of data traffic 230 within the resource(s) allocated via the resource allocation 220-b.

Further, the UE 115-a and the base station 105-a may communicate at least a portion of the expected amount of data traffic 230 in accordance with one or more additional actions taken by the base station 105-a in response to the indication of the expected amount of data traffic 230. For example, the UE 115-a, the base station 105-a, or both, may communicate the expected amount of data traffic 230 within an activated communication resource (e.g., activated SCell, activated BWP, activated component carrier) which was activated by the base station 105-a in response to the expected amount of data traffic 230 which was reported via the first uplink message 225-a. By way of another example, the UE 115-a and/or the base station 105-a may communicate the expected amount of data traffic 230 based on (e.g., in accordance with) one or more additional indications received via from the base station 105-a, including an indication to adjust the quantity of communication layers at the UE 115-a, an indication to adjust the HARQ process at the UE 115-a, or both.

In some cases, the base station 105-a may deactivate proactive traffic reporting within the wireless communications system 200. That is, the base station 105-a may deactivate, or otherwise disable, one or more proactive traffic reporting configurations which enable UEs 115 (e.g., UE 115-a) to proactively report expected data traffic 230 at the respective UEs 115.

In some implementations, the base station 105-a may deactivate/disable proactive traffic reporting based on monitoring the network traffic. For example, in some implementations, the base station 105-a may deactivate proactive traffic reporting (e.g., deactivate proactive traffic reporting configurations) in low-traffic conditions (e.g., when monitored traffic is less than some traffic threshold). In this regard, the base station 105-a may deactivate the proactive traffic reporting configuration based on an amount of data traffic 230 at the base station 105-a failing to satisfy (e.g., being less than) some data traffic 230 threshold.

In additional or alternative implementations, the base station 105-a may deactivate proactive traffic reporting in cases where the UE 115-a (and/or other UEs 115) are inaccurately predicting expected amounts of data traffic 230. In other words, the base station 105-a may deactivate the proactive traffic reporting configuration based on the difference (ΔT) between the actual scheduled/buffered amount of data traffic 230 (T_{Actual}) and the reported expected amount of data traffic 230 (T_{Expected}) (e.g., when ΔT satisfies some traffic change threshold). In such cases, the base station 105-a may deactivate proactive traffic reporting based on the first uplink message 225-a indicating the expected amount of data traffic 230, the second uplink message 225-b indicating the actual scheduled/buffered amount of data traffic 230, or both.

Subsequently, the UE 115-a may receive, from the base station 105-a, additional control signaling which indicates a deactivation of the proactive traffic reporting configuration. The base station 105-a may be configured to transmit the additional control signaling based on deactivating proactive traffic reporting. The control signaling indicating the deactivation of the proactive traffic reporting configuration may include an RRC message, a system information message, a MAC-CE, or any combination thereof.

Techniques described herein may enable the UE 115-a to proactively report expected uplink and downlink traffic which is expected at the UE 115-a, which may enable the network (e.g., base station 105-a) to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

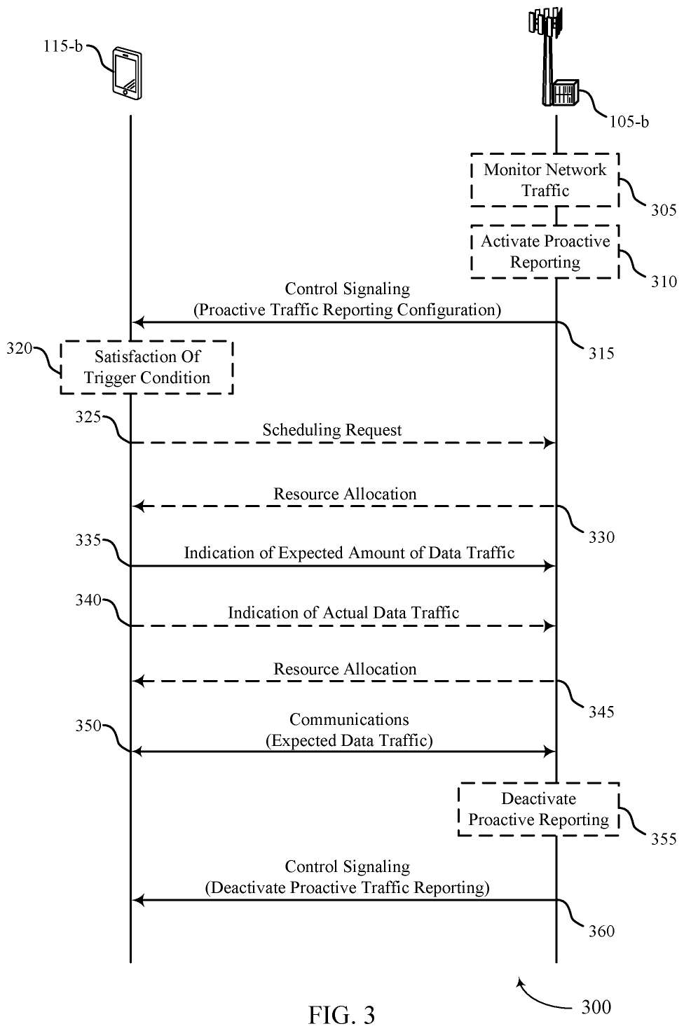

FIG. 3 illustrates an example of a process flow 300 that supports techniques for communicating expected data indication for network power savings in accordance with aspects of the present disclosure. In some examples, process flow 300 may implement, or be implemented by, aspects of wireless communications system 100, wireless communications system 200, or both. In particular, the process flow 300 techniques for proactively reporting expected data traffic at the UE 115-b, as described herein with reference to FIGS. 1-2, among other aspects.

The process flow 300 may include a UE 115-b and a base station 105-b, which may be examples of UEs 115 and base stations 105 as described herein with reference to FIGS. 1-2. For example, the UE 115-b and the base station 105-b illustrated in FIG. 3 may be examples of the UE 115-a and the base station 105-a, respectively, as illustrated in FIG. 2.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the base station 105-b may monitor network traffic within a wireless communications system (e.g., wireless communications system 100, 200). That is, the base station 105-b may monitor quantities of uplink, downlink, and sidelink traffic within the wireless communications system, including scheduling requests and indications of allocated resources. In particular, the base station 105-b may monitor an amount of network traffic which is scheduled (or expected) to be performed by the base station 105-b (e.g., scheduled/expected downlink/uplink traffic for the base station 105-b).

At 310, the base station 105-b may activate proactive traffic reporting within the wireless communications system. That is, the base station 105-b may activate, or otherwise enable, one or more proactive traffic reporting configurations which enable UEs 115 (e.g., UE 115-b) to proactively report expected data traffic at the respective UEs 115. In some implementations, the base station 105-b may activate/enable proactive traffic reporting based on monitoring the network traffic at 305.

For example, in some implementations, the base station 105-b may activate/enable proactive traffic reporting if an amount of network traffic monitored/observed at 305 satisfies (e.g., exceeds) some traffic threshold. In some aspects, the base station 105-b may activate proactive traffic reporting (e.g., activate proactive traffic reporting configurations) in high-traffic conditions in order to enable the base station 105-b to receive early indications of changes in traffic load. Such early indications of expected traffic may enable the base station 105-b to be more aggressive when adapting short-term variations in traffic load (e.g., enable the base station 105-b to deactivate radio resources even when they are not needed temporarily).

At 315, the UE 115-b may receive, from the base station 105-b, control signaling indicating a proactive traffic reporting configuration for proactively reporting expected data traffic for the UE 115-b. The base station 105-b may be configured to transmit the control signaling at 315 based on monitoring the network traffic at 305, activating proactive traffic reporting at 310, or both. For example, the control signaling may indicate that the proactive traffic reporting configuration has been activated for the UE 115-b. The control signaling indicating the proactive traffic reporting configuration may include an RRC message, a system information message, a MAC-CE, or any combination thereof.

In some aspects the proactive traffic reporting configuration may include (and/or indicate) one or more trigger conditions for proactively reporting expected data traffic for the UE 115-b. Trigger conditions may include any condition or metric at the UE 115-b, within the network, or both, that may be used to trigger proactive traffic reporting by the UE 115-b, including expected data thresholds, QoS requirements of data traffic, and the like. For example, a trigger condition may include a data threshold which, if satisfied, causes the UE 115-b to proactively report an expected amount of data traffic. For instance, the control signaling may indicate a data threshold associated with a trigger condition, where the UE 115-b may be configured to proactively report data traffic if an expected amount of data traffic at the UE 115-b is greater than or equal to the data threshold.

In some implementations, the control signaling may indicate how far in advance the UE 115-b is to predict or anticipate data traffic for the purposes of proactive data reporting. That is, the base station 105-b may indicate that the UE 115-b is only to predict/anticipate data traffic which is expected at the UE 115-b for some time threshold (e.g., 100-150 ms) in advance. Such time thresholds may prevent the UE 115-b from predicting expected data traffic far in advance, which may result in inaccurate traffic predictions. In this regard, in some aspects, the control signaling may indicate a time threshold associated with the trigger condition for proactively reporting expected data traffic. In such cases, the UE 115-b may be configured to estimate/predict expected data traffic which satisfies (e.g., falls within) the time threshold for the purposes of evaluating satisfaction of trigger conditions for proactive traffic reporting. In some cases, the time threshold may be pre-configured, dynamically adjusted and signaled by the base station 105-b (e.g., based on a quantity of network traffic), or both.

At 325, the UE 115-b may identify a satisfaction of one or more trigger conditions associated with the proactive traffic reporting configuration. In this regard, the UE 115-b may identify that a trigger condition for proactive traffic reporting has been satisfied, and that the UE 115-b is to proactively report expected data traffic to the base station 105-b. In some aspects, the satisfaction of the trigger condition may be based on an expected amount of data traffic at the UE 115-b (e.g., expected amount of downlink and/or uplink traffic at the UE 115-b). The UE 115-b may identify the satisfaction of the trigger condition(s) in accordance with the proactive traffic reporting configuration, which was indicated/configured via the control signaling at 315.

For example, the UE 115-b may determine an expected amount of data traffic which is to be transmitted and/or received by the UE 115-b at some time in the future. In this regard, the UE 115-b may identify an expected amount of data traffic which has not yet been scheduled for the UE 115-b, buffered by the UE 115-b, or both. Moreover, the expected amount of data traffic may include data traffic which is expected within a time threshold associated with a trigger condition (e.g., data traffic expected within the next 100 ms). In this example, the UE 115-b may identify that the expected amount of data traffic is greater than or equal to a data threshold associated with a trigger condition for proactive traffic reporting, and may therefore identify that the trigger condition has been satisfied. Further, the UE 115-b may identify that the trigger condition has been satisfied based on the expected amount of data traffic being expected within the respective time threshold (e.g., within the next 100 ms).

At 325, the UE 115-b may transmit a scheduling request to the base station 105-b, where the scheduling request includes a request for resources for proactively reporting data traffic at the UE 115-b. In other words, the UE 115-b may transmit a scheduling request for resources which will be used to transmit a proactive BSR. The UE 115-b may transmit the scheduling request at 325 based on receiving the control signaling at 315, identifying the satisfaction of the trigger condition(s) at 320, or both. For example, in some aspects, the scheduling request may include an indication that one or more trigger conditions for proactive traffic reporting have been satisfied at the UE 115-b.

At 330, the UE 115-b may receive a resource allocation from the base station 105-b. In some aspects, the UE 115-b may receive (and the base station 105-b may transmit) the resource allocation in response to the scheduling request at 325. In this regard, the base station 105-b may schedule or allocate resources which will be used by the UE 115-b to transmit an indication of expected data traffic at the UE 115-b (e.g., proactive BSR).

At 335, the UE 115-b may transmit, to the base station 105-b, an uplink message including an indication of the expected amount of data traffic for the UE 115-b. In this regard, the UE 115-b may transmit the uplink message indicating the expected amount of data traffic based on receiving the control signaling for the proactive traffic reporting configuration at 315, identifying the satisfaction of the trigger condition at 320, transmitting the scheduling request at 325, receiving the resource allocation at 330, or any combination thereof. For example, the UE 115-b may transmit the uplink message indicating the expected amount of data traffic within the resource(s) which was indicated via the resource allocation at 330, and based on the activation of the proactive traffic reporting configuration received via the control signaling at 315.

The type of uplink message used to communicate the expected amount of data traffic may be dependent upon the type of expected data traffic. For example, in cases where the expected amount of data traffic includes an expected amount of uplink data traffic for the UE 115-b (e.g., data traffic expected to be transmitted by the UE 115-b at some time in the future), the uplink message at 335 may include a BSR message, a MAC-CE message, or both. In such cases, the expected amount of data traffic may be indicated via one or more LCID fields associated with proactive traffic reporting within the BSR message and/or MAC-CE message. In other words, the BSR message and/or MAC-CE message may include dedicated fields (e.g., dedicated LCID fields) which are used to communicate indications of expected amounts of data traffic.

By way of another example, in cases where the expected amount of data traffic includes an expected amount of downlink data traffic for the UE 115-b (e.g., data traffic expected to be received by the UE 115-b at some time in the future), the uplink message at 335 may include a message of a random access procedure (e.g., RACH message), a UE assistance information message, or both.

In some implementations, the uplink message indicating the expected amount of data traffic may further indicate when the expected amount of data traffic is predicted/expected to be performed. In other words, the UE 115-b may indicate an expected time resource associated with the expected amount of data traffic. By indicating when the expected amount of data traffic is expected to be transmitted/received, the base station 105-b may be able to more efficiently estimate/predict data traffic within the wireless communications system, which may lead to more efficient use of resources and improved power consumption at the base station 105-b.

In some implementations, the UE 115-b may be configured to transmit multiple proactive BSR messages indicating expected amounts of data traffic. For example, the UE 115-b may transmit a first indication of a first expected amount of data traffic expected to be performed at time T1, and may transmit a second indication of a second expected amount of data traffic expected to be performed at time T2. In some cases, messages indicating expected amounts of data traffic may additionally include updates to previously-reported amounts of expected data traffic.

At 340, the UE 115-b may transmit a second uplink message (e.g., BSR, MAC-CE, RACH message, UE assistance information message, UCI message) indicating a scheduled amount of data traffic for the UE 115-b, a buffered amount of data traffic for the UE 115-b, or both. In this regard, the first uplink message at 335 (e.g., first stage BSR) may indicate expected/predicted data traffic for the UE 115-b, whereas the second uplink message at 340 (e.g., second stage BSR) indicates data traffic which has been actually scheduled and/or buffered at the UE 115-b. In this regard, the UE 115-b may transmit the second uplink message based on (e.g., in response to) transmitting the first uplink message indicating the expected amount of data traffic at 335.

In some aspects, the second uplink message may indicate amounts of scheduled/buffered data traffic as a difference in data traffic relative to the expected amount of data traffic reported via the first uplink message. In other words, in some cases, the UE 115-b may report amounts of actual scheduled/buffered data traffic as a delta (Δ) relative to the previously-reported expected amount of data traffic (e.g., change in data traffic with respect to the first stage). For example, in cases where the UE 115-b reports an expected amount of data traffic (T_{Expected}), but is scheduled with (or buffers) a different amount of data traffic (T_{Actual}), the second uplink message may indicate the scheduled/buffered data traffic as the actual amount of scheduled/buffered data traffic (e.g., indicate T_{Actual}), or may indicate the scheduled/buffered data traffic as a difference relative to the expected data traffic (e.g., indicate T_{Expected}−T_{Actual}=ΔT).

Upon receiving the uplink message(s) indicating expected amounts of data traffic and/or actually scheduled/buffered data traffic, it may be up to network implementation as to how (or whether) to act upon the received indications. That is, it may be up to the base station 105-b as to how the base station 105-b will respond to the indications of expected data traffic. Possible actions that may be performed by the base station 105-b in response to the indication of expected data traffic may include, but are not limited to, activating additional serving cells (e.g., activate additional SCells), switching to a wider BWP, activating additional component carriers, adjust a quantity of communication layers at the UE 115-b (e.g., increase a quantity of downlink MIMO layers at the UE 115-b), adjust a HARQ process at the UE 115-b (e.g., configure more HARQ processes, reduce HARQ processing time, reduce k0 for PDSCH), or any combination thereof. Actions taken by the base station 105-b may be further shown and described in step 345 of process flow 300.

At 345, the UE 115-b may receive a downlink message indicating a resource allocation for communicating at least a portion of the expected amount of data traffic. In other words, the base station 105-b may allocate resources which may be used by the UE 115-b to transmit/receive at least a portion of the expected amount of data traffic. In this regard, the UE 115-b may receive the downlink message including the resource allocation at 345 based on receiving the control signaling at 315, identifying the satisfaction of the trigger condition at 320, transmitting the scheduling request at 325, receiving the resource allocation at 330, transmitting the first uplink message indicating the expected amount of data traffic at 335, transmitting the second uplink message indicating the actual scheduled/buffered amount of data traffic at 340, or any combination thereof.

For example, in some cases, the base station 105-b may transmit the resource allocation to accommodate the entirety, or just a portion of, the expected amount of data traffic. In cases where the UE 115-b reports expected time resources for the expected amount of data traffic (e.g., time resources in which the expected amount of data traffic is to be performed), the base station 105-b may allocate resources based on the expected time resources. Moreover, in some cases, the base station 105-b may transmit the resource allocation at 345 based on an indication of actually scheduled/buffered data traffic indicated via the second uplink message. In this regard, the base station 105-b may allocate resources based on indicated differences between the expected data traffic and the actually scheduled/buffered data traffic.

As noted previously herein, the base station 105-b may perform several actions that in response to the indication of expected data traffic including, but not limited to, activating additional serving cells (e.g., activate additional SCells), switching to a wider BWP, activating additional component carriers, adjusting a quantity of communication layers at the UE 115-b, adjusting a HARQ process at the UE 115-b, or any combination thereof. In this regard, the downlink message at 345 may additionally or alternatively indicate one or more actions that the base station 105-b has taken (or will take) in response to the expected amount of data traffic.

For example, in some cases, the downlink message may include an indication of an activated communications resource that has been activated in response to the expected amount of data traffic, where the activated communications resource includes an activated component carrier, an activated bandwidth part, an activated serving cell supported by the base station 105-b (e.g., activated SCell), or any combination thereof. By way of another example, the downlink message may include an indication to selectively adjust a quantity of communication layers used for communications at the UE 115-b (e.g., increase a maximum quantity of downlink MIMO layers at the UE 115-b), an indication to selectively adjust a HARQ process at the UE 115-b, or both.

At 350, the UE 115-b may communicate at least a portion of the expected amount of data traffic. For example, the UE 115-b and the base station 105-b may communicate the expected amount of data traffic with one another. In particular, the UE 115-b, the base station 105-b, or both, may communicate the expected data traffic (which was reported via the first uplink message at 335) in accordance with the proactive traffic reporting configuration. Moreover, the UE 115-b and the base station 105-b may communicate the expected amount of data traffic within the resource(s) allocated via the resource allocation at 345.

Further, the UE 115-b and the base station 105-b may communicate at least a portion of the expected amount of data traffic in accordance with one or more additional actions taken by the base station 105-b in response to the indication of the expected amount of data traffic. For example, the UE 115-b, the base station 105-b, or both, may communicate the expected amount of data traffic within an activated communication resource (e.g., activated SCell, activated BWP, activated component carrier) which was activated by the base station 105-b in response to the expected amount of data traffic which was reported via the first uplink message. By way of another example, the UE 115-b and/or the base station 105-b may communicate the expected amount of data traffic based on (e.g., in accordance with) one or more additional indications received via the downlink message at 345, including an indication to adjust the quantity of communication layers at the UE 115-b, an indication to adjust the HARQ process at the UE 115-b, or both.

At 355, the base station 105-b may deactivate proactive traffic reporting within the wireless communications system. That is, the base station 105-b may deactivate, or otherwise disable, one or more proactive traffic reporting configurations which enable UEs 115 (e.g., UE 115-b) to proactively report expected data traffic at the respective UEs 115.

In some implementations, the base station 105-b may deactivate/disable proactive traffic reporting based on monitoring the network traffic at 305 (and continuous/periodic traffic monitoring). For example, in some implementations, the base station 105-b may deactivate proactive traffic reporting (e.g., deactivate proactive traffic reporting configurations) in low-traffic conditions (e.g., when monitored traffic is less than some traffic threshold). In this regard, the base station 105-b may deactivate the proactive traffic reporting configuration based on an amount of data traffic at the base station 105-b failing to satisfy (e.g., being less than) some data traffic threshold.

In additional or alternative implementations, the base station 105-b may deactivate proactive traffic reporting in cases where the UE 115-b (and/or other UEs 115) are inaccurately predicting expected amounts of data traffic. In other words, the base station 105-b may deactivate the proactive traffic reporting configuration based on the difference (ΔT) between the actual scheduled/buffered amount of data traffic (T_{Actual}) and the reported expected amount of data traffic (T_{Expected}) (e.g., when ΔT satisfies some traffic change threshold). In such cases, the base station 105-b may deactivate proactive traffic reporting based on the first uplink message indicating the expected amount of data traffic, the second uplink message indicating the actual scheduled/buffered amount of data traffic, or both.

At 360, the UE 115-b may receive, from the base station 105-b, control signaling which indicates a deactivation of the proactive traffic reporting configuration. The base station 105-b may be configured to transmit the control signaling at 360 based on deactivating proactive traffic reporting at 355. The control signaling indicating the deactivation of the proactive traffic reporting configuration may include an RRC message, a system information message, a MAC-CE, or any combination thereof.

Techniques described herein may enable the UE 115-b to proactively report expected uplink and downlink traffic which is expected at the UE 115-b, which may enable the network (e.g., base station 105-b) to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

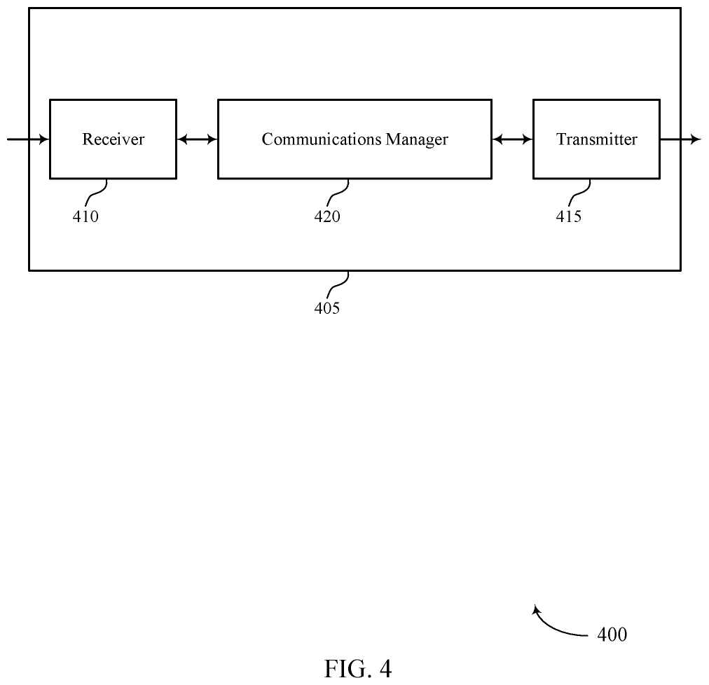

FIG. 4 shows a block diagram 400 of a device 405 that supports techniques for communicating expected data indication for network power savings in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for communicating expected data indication for network power savings). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for communicating expected data indication for network power savings). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for communicating expected data indication for network power savings as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

For example, the communications manager 420 may be configured as or otherwise support a means for receiving, from a base station, control signaling indicating a proactive traffic reporting configuration identifying a trigger condition for proactively reporting expected data traffic for the UE. The communications manager 420 may be configured as or otherwise support a means for transmitting, to the base station based on a satisfaction of the trigger condition, an uplink message including an indication of an expected amount of data traffic for the UE, where the satisfaction of the trigger condition is based on the expected amount of data traffic. The communications manager 420 may be configured as or otherwise support a means for receiving, in response to the uplink message, a downlink message indicating a resource allocated for communicating the expected amount of data traffic. The communications manager 420 may be configured as or otherwise support a means for communicating at least a portion of the expected amount of data traffic with the base station via the indicated resource.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for proactively reporting expected uplink and downlink traffic which is expected at the UEs 115, which may enable the network to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

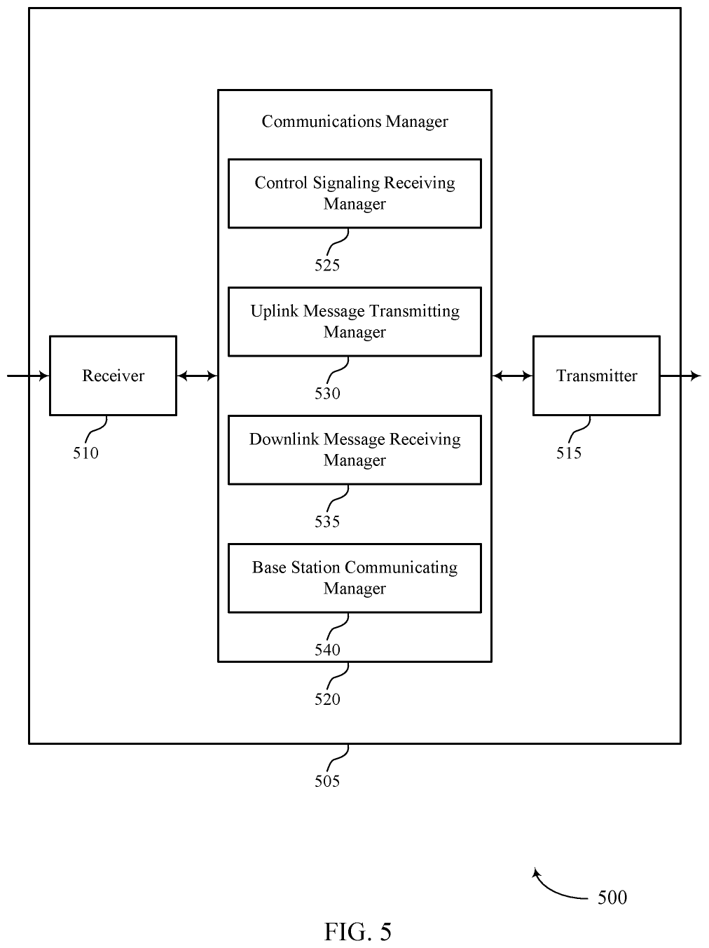

FIG. 5 shows a block diagram 500 of a device 505 that supports techniques for communicating expected data indication for network power savings in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for communicating expected data indication for network power savings). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for communicating expected data indication for network power savings). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for communicating expected data indication for network power savings as described herein. For example, the communications manager 520 may include a control signaling receiving manager 525, an uplink message transmitting manager 530, a downlink message receiving manager 535, a base station communicating manager 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The control signaling receiving manager 525 may be configured as or otherwise support a means for receiving, from a base station, control signaling indicating a proactive traffic reporting configuration identifying a trigger condition for proactively reporting expected data traffic for the UE. The uplink message transmitting manager 530 may be configured as or otherwise support a means for transmitting, to the base station based on a satisfaction of the trigger condition, an uplink message including an indication of an expected amount of data traffic for the UE, where the satisfaction of the trigger condition is based on the expected amount of data traffic. The downlink message receiving manager 535 may be configured as or otherwise support a means for receiving, in response to the uplink message, a downlink message indicating a resource allocated for communicating the expected amount of data traffic. The base station communicating manager 540 may be configured as or otherwise support a means for communicating at least a portion of the expected amount of data traffic with the base station via the indicated resource.

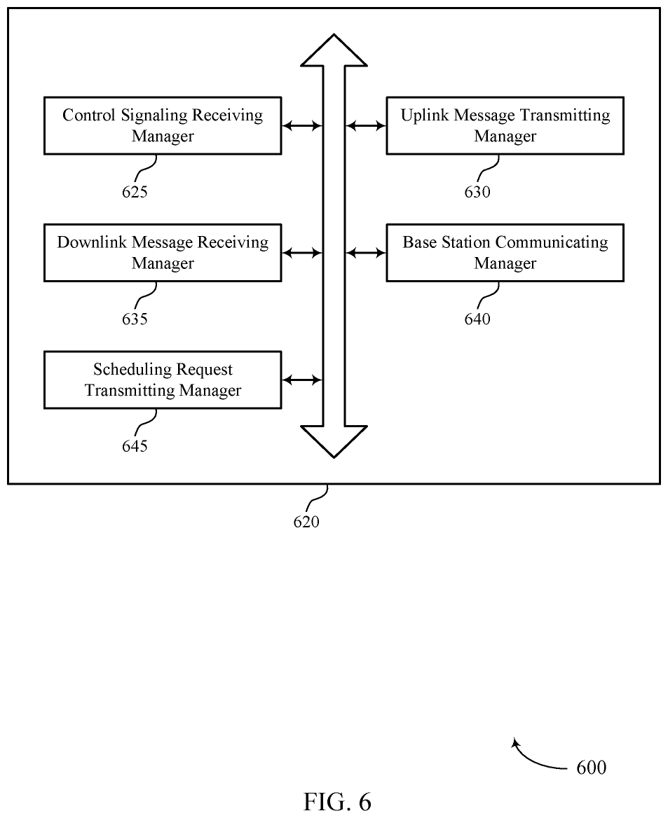

FIG. 6 shows a block diagram 600 of a communications manager 620 that supports techniques for communicating expected data indication for network power savings in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for communicating expected data indication for network power savings as described herein. For example, the communications manager 620 may include a control signaling receiving manager 625, an uplink message transmitting manager 630, a downlink message receiving manager 635, a base station communicating manager 640, a scheduling request transmitting manager 645, or any combination thereof. Each of these components may communicate, directly or indirectly, with one another (e.g., via one or more buses).

The control signaling receiving manager 625 may be configured as or otherwise support a means for receiving, from a base station, control signaling indicating a proactive traffic reporting configuration identifying a trigger condition for proactively reporting expected data traffic for the UE. The uplink message transmitting manager 630 may be configured as or otherwise support a means for transmitting, to the base station based on a satisfaction of the trigger condition, an uplink message including an indication of an expected amount of data traffic for the UE, where the satisfaction of the trigger condition is based on the expected amount of data traffic. The downlink message receiving manager 635 may be configured as or otherwise support a means for receiving, in response to the uplink message, a downlink message indicating a resource allocated for communicating the expected amount of data traffic. The base station communicating manager 640 may be configured as or otherwise support a means for communicating at least a portion of the expected amount of data traffic with the base station via the indicated resource.

In some examples, the uplink message transmitting manager 630 may be configured as or otherwise support a means for transmitting, to the base station and based on transmitting the uplink message, a second uplink message including an indication of a scheduled amount of data traffic for the UE, a buffered amount of data traffic for the UE, or both, where receiving the downlink message, communicating at least the portion of the expected amount of data traffic, or both, is based on the second uplink message.

In some examples, the uplink message transmitting manager 630 may be configured as or otherwise support a means for transmitting, via the second uplink message, an indication of a first difference between the expected amount of data traffic and the scheduled amount of data traffic, a second difference between the expected amount of data traffic and the buffered amount of data traffic, or both, where receiving the downlink message, communicating at least the portion of the expected amount of data traffic, or both, is based on the first difference, the second difference, or both.

In some examples, the control signaling receiving manager 625 may be configured as or otherwise support a means for receiving, via the control signaling, an indication of a data threshold associated with the trigger condition for proactively reporting expected data traffic, where the satisfaction of the trigger condition is based on the expected amount of data traffic being greater than or equal to the data threshold. In some examples, the control signaling receiving manager 625 may be configured as or otherwise support a means for receiving, via the control signaling, an indication of a time threshold associated with the trigger condition for proactively reporting expected data traffic, where the satisfaction of the trigger condition is based on the expected amount of data traffic being expected within the time threshold.

In some examples, the control signaling receiving manager 625 may be configured as or otherwise support a means for receiving, via the control signaling, an activation of the proactive traffic reporting configuration, where transmitting the uplink message is based on the activation of the proactive traffic reporting configuration.

In some examples, the uplink message transmitting manager 630 may be configured as or otherwise support a means for transmitting, via the uplink message, an expected time resource associated with the expected amount of data traffic, where the resource allocated for communicating the expected amount of data traffic is based on the expected time resource. In some examples, the uplink message transmitting manager 630 may be configured as or otherwise support a means for transmitting, to the base station, a second uplink message including an indication of a second expected amount of data traffic for the UE, an indication of a change in the expected amount of data traffic for the UE, or both, where receiving the downlink message, communicating the portion of the expected amount of data traffic, or both, is based on the second uplink message.

In some examples, the scheduling request transmitting manager 645 may be configured as or otherwise support a means for transmitting a scheduling request to the base station based on the satisfaction of the trigger condition. In some examples, the downlink message receiving manager 635 may be configured as or otherwise support a means for receiving, from the base station in response to the scheduling request, an indication of a second resource for communicating the uplink message, where the uplink message is transmitted within the second resource.

In some examples, the downlink message receiving manager 635 may be configured as or otherwise support a means for receiving, via the downlink message, an indication of an activated communications resource that has been activated in response to the expected amount of data traffic, where the portion of the expected amount of data traffic is communicated within the activated communications resource, and where the activated communications resource includes an activated component carrier, an activated BWP, an activated serving cell supported by the base station, or any combination thereof.

In some examples, the downlink message receiving manager 635 may be configured as or otherwise support a means for receiving, via the downlink message, an indication to selectively adjust a quantity of communication layers used for communications at the UE, an indication to selectively adjust a HARQ process, or both, where communicating the portion of the expected amount of data traffic is based on the indication to selectively adjust a quantity of communication layers used for communications at the UE, the indication to selectively adjust the HARQ process, or both.

In some examples, the expected amount of data traffic includes an expected amount of uplink data traffic for the UE. In some examples, the uplink message includes a BSR message, a MAC-CE message, or both. In some examples, the expected amount of data traffic is indicated via one or more LCID fields within the BSR message, within the MAC-CE message, or both. In some examples, the one or more LCID fields are associated with proactively reporting expected data traffic for the UE.

In some examples, the expected amount of data traffic includes an expected amount of downlink data traffic for the UE. In some examples, the uplink message includes a message of a random access procedure, a UE assistance information message, or both. In some examples, the expected amount of data traffic includes an amount of data traffic which has not yet been scheduled for the UE, buffered by the UE, or both.

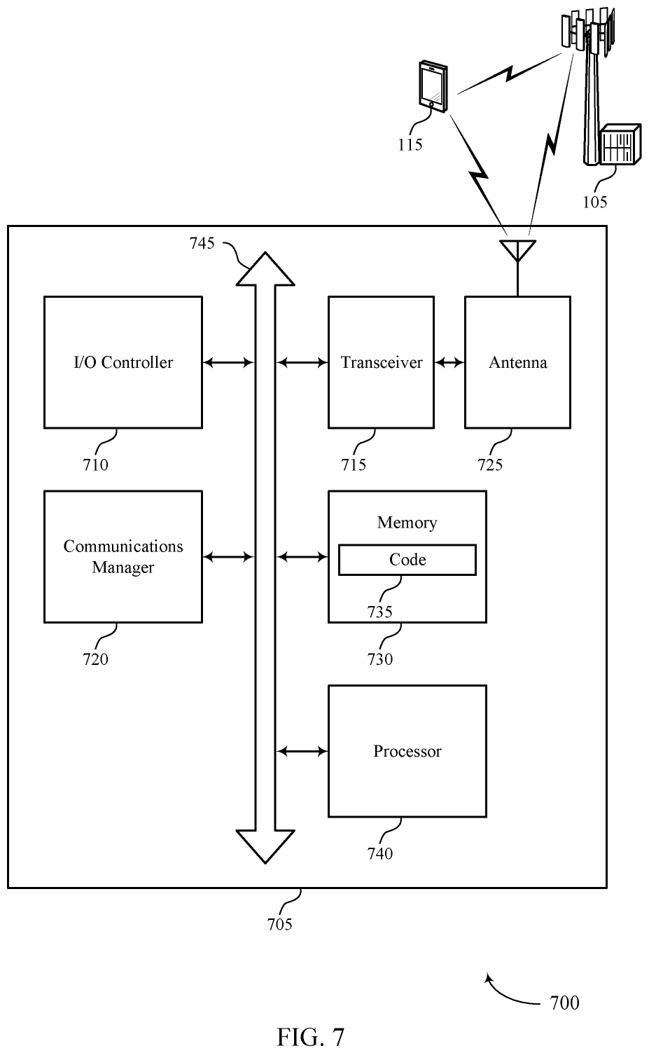

FIG. 7 shows a diagram of a system 700 including a device 705 that supports techniques for communicating expected data indication for network power savings in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for communicating expected data indication for network power savings). For example, the device 705 or a component of the device 705 may include a processor 740 and memory 730 coupled to the processor 740, the processor 740 and memory 730 configured to perform various functions described herein.

For example, the communications manager 720 may be configured as or otherwise support a means for receiving, from a base station, control signaling indicating a proactive traffic reporting configuration identifying a trigger condition for proactively reporting expected data traffic for the UE. The communications manager 720 may be configured as or otherwise support a means for transmitting, to the base station based on a satisfaction of the trigger condition, an uplink message including an indication of an expected amount of data traffic for the UE, where the satisfaction of the trigger condition is based on the expected amount of data traffic. The communications manager 720 may be configured as or otherwise support a means for receiving, in response to the uplink message, a downlink message indicating a resource allocated for communicating the expected amount of data traffic. The communications manager 720 may be configured as or otherwise support a means for communicating at least a portion of the expected amount of data traffic with the base station via the indicated resource.

By including or configuring the communications manager 720 in accordance with examples as described herein, the device 705 may support techniques for proactively reporting expected uplink and downlink traffic which is expected at the UEs 115, which may enable the network to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for communicating expected data indication for network power savings as described herein, or the processor 740 and the memory 730 may be otherwise configured to perform or support such operations.

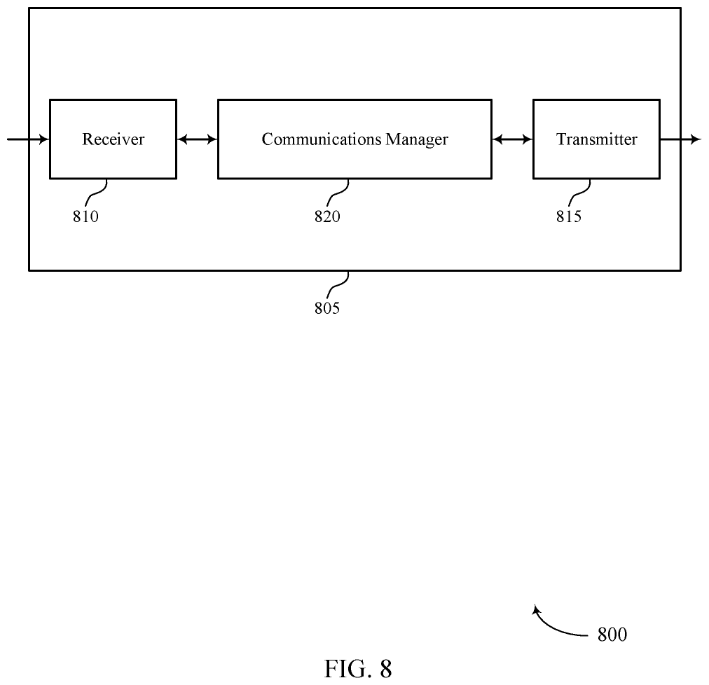

FIG. 8 shows a block diagram 800 of a device 805 that supports techniques for communicating expected data indication for network power savings in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for communicating expected data indication for network power savings). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for communicating expected data indication for network power savings). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for communicating expected data indication for network power savings as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

For example, the communications manager 820 may be configured as or otherwise support a means for transmitting, to a UE, control signaling indicating a proactive traffic reporting configuration identifying a trigger condition for proactively reporting expected data traffic for the UE. The communications manager 820 may be configured as or otherwise support a means for receiving, from the UE based on a satisfaction of the trigger condition, an uplink message including an indication of an expected amount of data traffic for the UE, where the satisfaction of the trigger condition is based on the expected amount of data traffic. The communications manager 820 may be configured as or otherwise support a means for transmitting, in response to the uplink message, a downlink message indicating a resource allocated for communicating the expected amount of data traffic. The communications manager 820 may be configured as or otherwise support a means for communicating at least a portion of the expected amount of data traffic with the UE via the indicated resource.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for proactively reporting expected uplink and downlink traffic which is expected at the UEs 115, which may enable the network to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

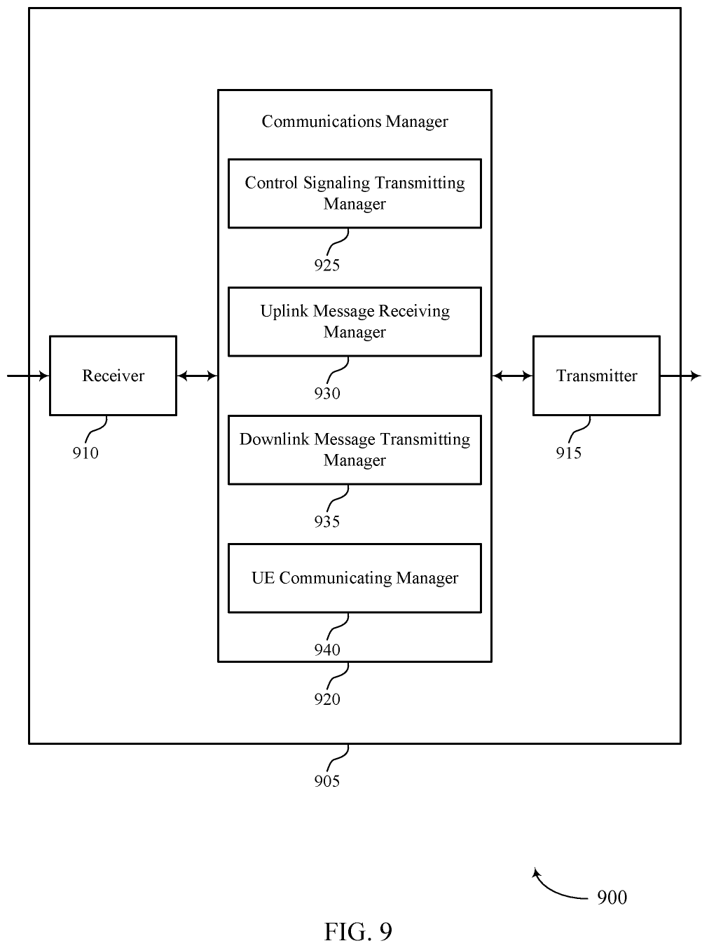

FIG. 9 shows a block diagram 900 of a device 905 that supports techniques for communicating expected data indication for network power savings in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for communicating expected data indication for network power savings). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for communicating expected data indication for network power savings). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for communicating expected data indication for network power savings as described herein. For example, the communications manager 920 may include a control signaling transmitting manager 925, an uplink message receiving manager 930, a downlink message transmitting manager 935, a UE communicating manager 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The control signaling transmitting manager 925 may be configured as or otherwise support a means for transmitting, to a UE, control signaling indicating a proactive traffic reporting configuration identifying a trigger condition for proactively reporting expected data traffic for the UE. The uplink message receiving manager 930 may be configured as or otherwise support a means for receiving, from the UE based on a satisfaction of the trigger condition, an uplink message including an indication of an expected amount of data traffic for the UE, where the satisfaction of the trigger condition is based on the expected amount of data traffic. The downlink message transmitting manager 935 may be configured as or otherwise support a means for transmitting, in response to the uplink message, a downlink message indicating a resource allocated for communicating the expected amount of data traffic. The UE communicating manager 940 may be configured as or otherwise support a means for communicating at least a portion of the expected amount of data traffic with the UE via the indicated resource.

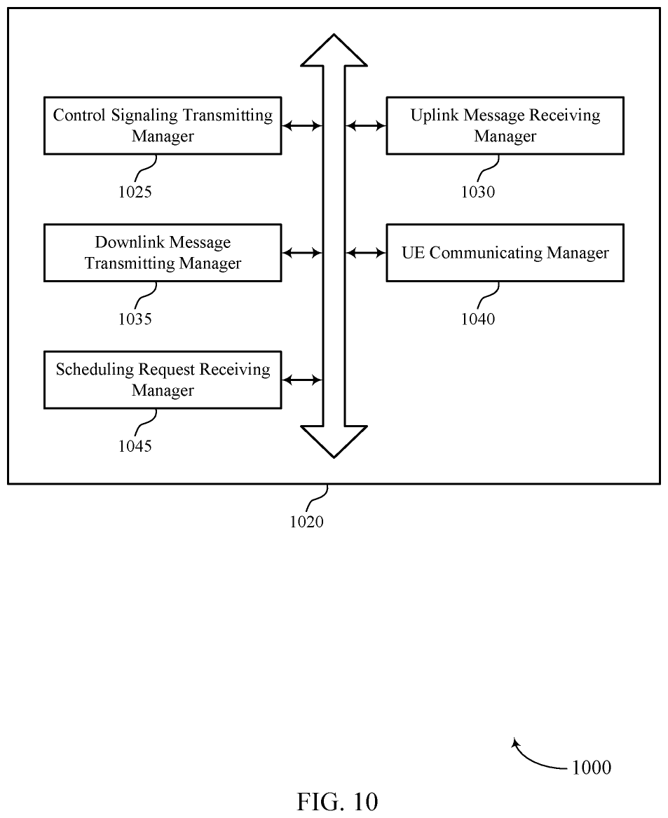

FIG. 10 shows a block diagram 1000 of a communications manager 1020 that supports techniques for communicating expected data indication for network power savings in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for communicating expected data indication for network power savings as described herein. For example, the communications manager 1020 may include a control signaling transmitting manager 1025, an uplink message receiving manager 1030, a downlink message transmitting manager 1035, a UE communicating manager 1040, a scheduling request receiving manager 1045, or any combination thereof. Each of these components may communicate, directly or indirectly, with one another (e.g., via one or more buses).

The control signaling transmitting manager 1025 may be configured as or otherwise support a means for transmitting, to a UE, control signaling indicating a proactive traffic reporting configuration identifying a trigger condition for proactively reporting expected data traffic for the UE. The uplink message receiving manager 1030 may be configured as or otherwise support a means for receiving, from the UE based on a satisfaction of the trigger condition, an uplink message including an indication of an expected amount of data traffic for the UE, where the satisfaction of the trigger condition is based on the expected amount of data traffic. The downlink message transmitting manager 1035 may be configured as or otherwise support a means for transmitting, in response to the uplink message, a downlink message indicating a resource allocated for communicating the expected amount of data traffic. The UE communicating manager 1040 may be configured as or otherwise support a means for communicating at least a portion of the expected amount of data traffic with the UE via the indicated resource.

In some examples, the uplink message receiving manager 1030 may be configured as or otherwise support a means for receiving, from the UE and based on transmitting the uplink message, a second uplink message including an indication of a scheduled amount of data traffic for the UE, a buffered amount of data traffic for the UE, or both, where transmitting the downlink message, communicating at least the portion of the expected amount of data traffic, or both, is based on the second uplink message.

In some examples, the uplink message receiving manager 1030 may be configured as or otherwise support a means for receiving, via the second uplink message, an indication of a first difference between the expected amount of data traffic and the scheduled amount of data traffic, a second difference between the expected amount of data traffic and the buffered amount of data traffic, or both, where transmitting the downlink message, communicating at least the portion of the expected amount of data traffic, or both, is based on the first difference, the second difference, or both.

In some examples, the downlink message transmitting manager 1035 may be configured as or otherwise support a means for transmitting, to the UE based on the first difference, the second difference, or both, a second downlink message indicating a deactivation of the proactive traffic reporting configuration.

In some examples, the control signaling transmitting manager 1025 may be configured as or otherwise support a means for transmitting, via the control signaling, an indication of a data threshold associated with the trigger condition for proactively reporting expected data traffic, where the satisfaction of the trigger condition is based on the expected amount of data traffic being greater than or equal to the data threshold. In some examples, the control signaling transmitting manager 1025 may be configured as or otherwise support a means for transmitting, via the control signaling, an indication of a time threshold associated with the trigger condition for proactively reporting expected data traffic, where the satisfaction of the trigger condition is based on the expected amount of data traffic being expected within the time threshold.

In some examples, the control signaling transmitting manager 1025 may be configured as or otherwise support a means for transmitting, via the control signaling, an activation of the proactive traffic reporting configuration, where receiving the uplink message is based on the activation of the proactive traffic reporting configuration. In some examples, the control signaling transmitting manager 1025 may be configured as or otherwise support a means for transmitting, via the control signaling, the activation of the proactive traffic reporting configuration based on an amount of data traffic for the base station satisfying a data traffic threshold.

In some examples, the downlink message transmitting manager 1035 may be configured as or otherwise support a means for transmitting, to the UE, a second downlink message including a deactivation of the proactive traffic reporting configuration based on an amount of data traffic for the base station failing to satisfy a data traffic threshold.

In some examples, the uplink message receiving manager 1030 may be configured as or otherwise support a means for receiving, via the uplink message, an expected time resource associated with the expected amount of data traffic, where the resource allocated for communicating the expected amount of data traffic is based on the expected time resource. In some examples, the uplink message receiving manager 1030 may be configured as or otherwise support a means for receiving, from the UE, a second uplink message including an indication of a second expected amount of data traffic for the UE, an indication of a change in the expected amount of data traffic for the UE, or both, where transmitting the downlink message, communicating the portion of the expected amount of data traffic, or both, is based on the second uplink message.

In some examples, the scheduling request receiving manager 1045 may be configured as or otherwise support a means for receiving a scheduling request to the base station based on the satisfaction of the trigger condition. In some examples, the downlink message transmitting manager 1035 may be configured as or otherwise support a means for transmitting, to the UE in response to the scheduling request, an indication of a second resource for communicating the uplink message, where the uplink message is received within the second resource.

In some examples, the downlink message transmitting manager 1035 may be configured as or otherwise support a means for transmitting, via the downlink message, an indication of an activated communications resource that has been activated in response to the expected amount of data traffic, where the portion of the expected amount of data traffic is communicated within the activated communications resource, and where the activated communications resource includes an activated component carrier, an activated BWP, an activated serving cell supported by the base station, or any combination thereof.

In some examples, the downlink message transmitting manager 1035 may be configured as or otherwise support a means for transmitting, via the downlink message, an indication to selectively adjust a quantity of communication layers used for communications at the UE, an indication to selectively adjust a HARQ process, or both, where communicating the portion of the expected amount of data traffic is based on the indication to selectively adjust a quantity of communication layers used for communications at the UE, the indication to selectively adjust the HARQ process, or both.

In some examples, the expected amount of data traffic includes an expected amount of uplink data traffic for the UE. In some examples, the uplink message includes a BSR message, a MAC-CE message, or both. In some examples, the expected amount of data traffic is indicated via one or more LCID fields within the BSR message, within the MAC-CE message, or both. In some examples, the one or more LCID fields are associated with proactively reporting expected data traffic for the UE.

In some examples, the expected amount of data traffic includes an expected amount of downlink data traffic for the UE. In some examples, the uplink message includes a message of a random access procedure, a UE assistance information message, or both. In some examples, the expected amount of data traffic includes an amount of data traffic which has not yet been scheduled for the UE, buffered by the UE, or both.

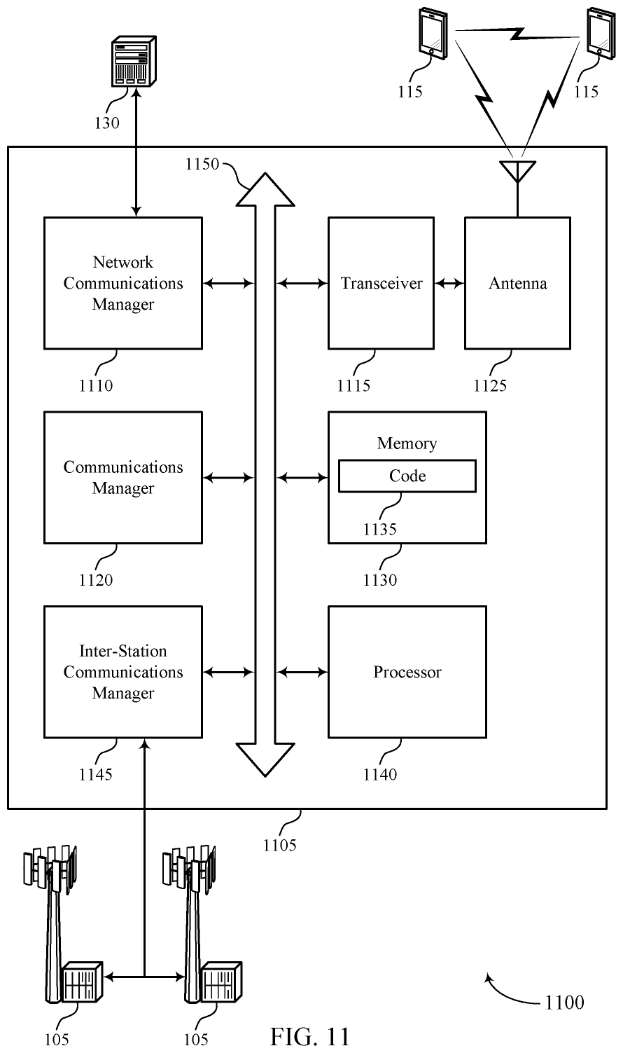

FIG. 11 shows a diagram of a system 1100 including a device 1105 that supports techniques for communicating expected data indication for network power savings in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for communicating expected data indication for network power savings). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

For example, the communications manager 1120 may be configured as or otherwise support a means for transmitting, to a UE, control signaling indicating a proactive traffic reporting configuration identifying a trigger condition for proactively reporting expected data traffic for the UE. The communications manager 1120 may be configured as or otherwise support a means for receiving, from the UE based on a satisfaction of the trigger condition, an uplink message including an indication of an expected amount of data traffic for the UE, where the satisfaction of the trigger condition is based on the expected amount of data traffic. The communications manager 1120 may be configured as or otherwise support a means for transmitting, in response to the uplink message, a downlink message indicating a resource allocated for communicating the expected amount of data traffic. The communications manager 1120 may be configured as or otherwise support a means for communicating at least a portion of the expected amount of data traffic with the UE via the indicated resource.

By including or configuring the communications manager 1120 in accordance with examples as described herein, the device 1105 may support techniques for proactively reporting expected uplink and downlink traffic which is expected at the UEs 115, which may enable the network to more accurately estimate traffic load throughout the network. Accordingly, aspects of the present disclosure may enable the network to more accurately and efficiently allocate wireless resources within the network, which may lead to more reliable wireless communications. Moreover, by enabling the network to more accurately estimate and allocate resources based on traffic across the network, techniques described herein may prevent the network from allocating more resources than necessary to handle traffic within the network (e.g., prevent “over-allocating” resources), which may reduce power consumption, and improve an overall power efficiency within the network.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for communicating expected data indication for network power savings as described herein, or the processor 1140 and the memory 1130 may be otherwise configured to perform or support such operations.

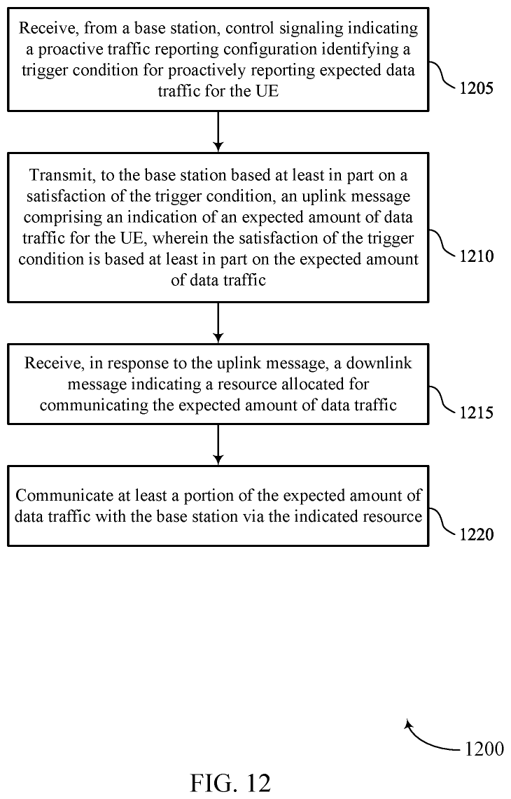

FIG. 12 shows a flowchart illustrating a method 1200 that supports techniques for communicating expected data indication for network power savings in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include receiving, from a base station, control signaling indicating a proactive traffic reporting configuration identifying a trigger condition for proactively reporting expected data traffic for the UE. The operations of 1205 may be performed in accordance with examples as disclosed herein. In some examples, aspects of the operations of 1205 may be performed by a control signaling receiving manager 625 as described with reference to FIG. 6.

At 1210, the method may include transmitting, to the base station based on a satisfaction of the trigger condition, an uplink message including an indication of an expected amount of data traffic for the UE, where the satisfaction of the trigger condition is based on the expected amount of data traffic. The operations of 1210 may be performed in accordance with examples as disclosed herein. In some examples, aspects of the operations of 1210 may be performed by an uplink message transmitting manager 630 as described with reference to FIG. 6.

At 1215, the method may include receiving, in response to the uplink message, a downlink message indicating a resource allocated for communicating the expected amount of data traffic. The operations of 1215 may be performed in accordance with examples as disclosed herein. In some examples, aspects of the operations of 1215 may be performed by a downlink message receiving manager 635 as described with reference to FIG. 6.

At 1220, the method may include communicating at least a portion of the expected amount of data traffic with the base station via the indicated resource. The operations of 1220 may be performed in accordance with examples as disclosed herein. In some examples, aspects of the operations of 1220 may be performed by a base station communicating manager 640 as described with reference to FIG. 6.

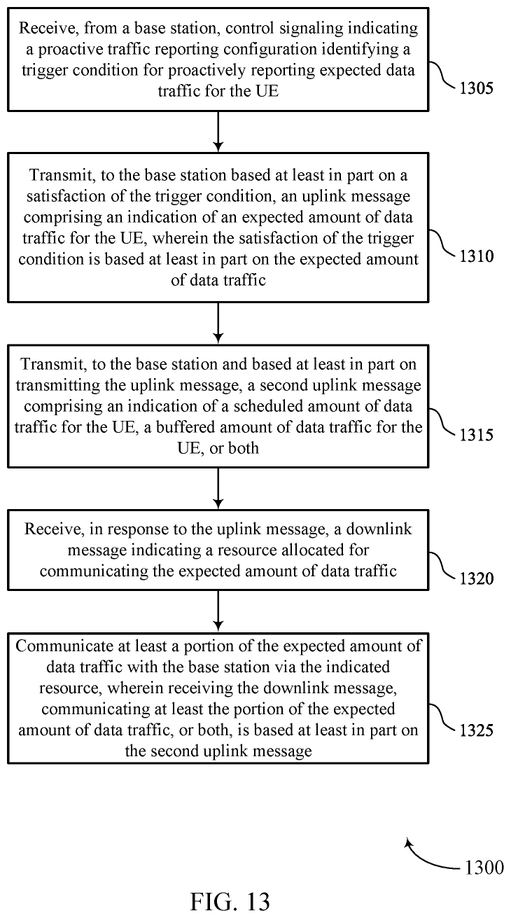

FIG. 13 shows a flowchart illustrating a method 1300 that supports techniques for communicating expected data indication for network power savings in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, control signaling indicating a proactive traffic reporting configuration identifying a trigger condition for proactively reporting expected data traffic for the UE. The operations of 1305 may be performed in accordance with examples as disclosed herein. In some examples, aspects of the operations of 1305 may be performed by a control signaling receiving manager 625 as described with reference to FIG. 6.

At 1310, the method may include transmitting, to the base station based on a satisfaction of the trigger condition, an uplink message including an indication of an expected amount of data traffic for the UE, where the satisfaction of the trigger condition is based on the expected amount of data traffic. The operations of 1310 may be performed in accordance with examples as disclosed herein. In some examples, aspects of the operations of 1310 may be performed by an uplink message transmitting manager 630 as described with reference to FIG. 6.

At 1315, the method may include transmitting, to the base station and based on transmitting the uplink message, a second uplink message including an indication of a scheduled amount of data traffic for the UE, a buffered amount of data traffic for the UE, or both. The operations of 1315 may be performed in accordance with examples as disclosed herein. In some examples, aspects of the operations of 1315 may be performed by an uplink message transmitting manager 630 as described with reference to FIG. 6.

At 1320, the method may include receiving, in response to the uplink message, a downlink message indicating a resource allocated for communicating the expected amount of data traffic. The operations of 1320 may be performed in accordance with examples as disclosed herein. In some examples, aspects of the operations of 1320 may be performed by a downlink message receiving manager 635 as described with reference to FIG. 6.

At 1325, the method may include communicating at least a portion of the expected amount of data traffic with the base station via the indicated resource, where receiving the downlink message, communicating at least the portion of the expected amount of data traffic, or both, is based on the second uplink message. The operations of 1325 may be performed in accordance with examples as disclosed herein. In some examples, aspects of the operations of 1325 may be performed by a base station communicating manager 640 as described with reference to FIG. 6.

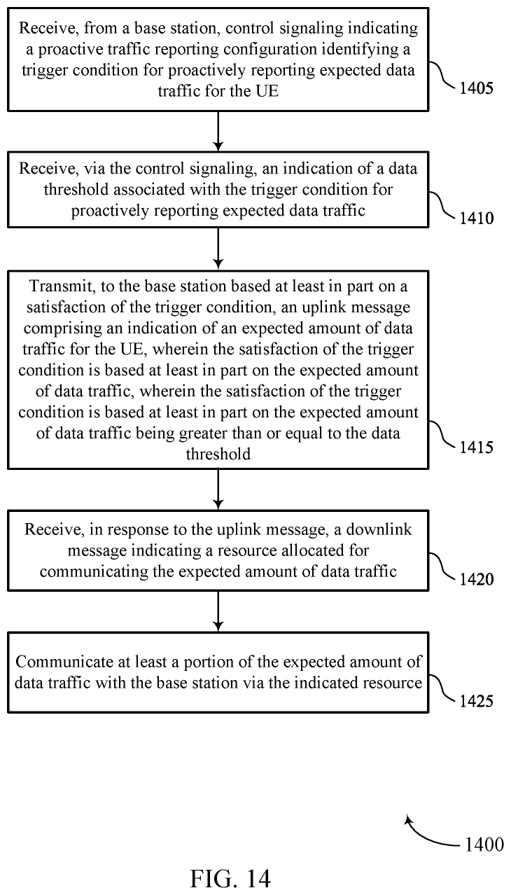

FIG. 14 shows a flowchart illustrating a method 1400 that supports techniques for communicating expected data indication for network power savings in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a proactive traffic reporting configuration identifying a trigger condition for proactively reporting expected data traffic for the UE. The operations of 1405 may be performed in accordance with examples as disclosed herein. In some examples, aspects of the operations of 1405 may be performed by a control signaling receiving manager 625 as described with reference to FIG. 6.

At 1410, the method may include receiving, via the control signaling, an indication of a data threshold associated with the trigger condition for proactively reporting expected data traffic. The operations of 1410 may be performed in accordance with examples as disclosed herein. In some examples, aspects of the operations of 1410 may be performed by a control signaling receiving manager 625 as described with reference to FIG. 6.

At 1415, the method may include transmitting, to the base station based on a satisfaction of the trigger condition, an uplink message including an indication of an expected amount of data traffic for the UE, where the satisfaction of the trigger condition is based on the expected amount of data traffic, where the satisfaction of the trigger condition is based on the expected amount of data traffic being greater than or equal to the data threshold. The operations of 1415 may be performed in accordance with examples as disclosed herein. In some examples, aspects of the operations of 1415 may be performed by an uplink message transmitting manager 630 as described with reference to FIG. 6.

At 1420, the method may include receiving, in response to the uplink message, a downlink message indicating a resource allocated for communicating the expected amount of data traffic. The operations of 1420 may be performed in accordance with examples as disclosed herein. In some examples, aspects of the operations of 1420 may be performed by a downlink message receiving manager 635 as described with reference to FIG. 6.

At 1425, the method may include communicating at least a portion of the expected amount of data traffic with the base station via the indicated resource. The operations of 1425 may be performed in accordance with examples as disclosed herein. In some examples, aspects of the operations of 1425 may be performed by a base station communicating manager 640 as described with reference to FIG. 6.

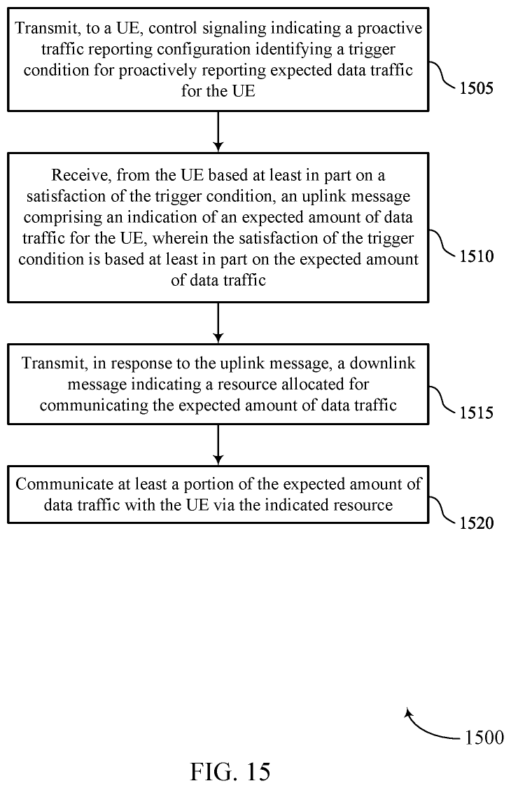

FIG. 15 shows a flowchart illustrating a method 1500 that supports techniques for communicating expected data indication for network power savings in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling indicating a proactive traffic reporting configuration identifying a trigger condition for proactively reporting expected data traffic for the UE. The operations of 1505 may be performed in accordance with examples as disclosed herein. In some examples, aspects of the operations of 1505 may be performed by a control signaling transmitting manager 1025 as described with reference to FIG. 10.

At 1510, the method may include receiving, from the UE based on a satisfaction of the trigger condition, an uplink message including an indication of an expected amount of data traffic for the UE, where the satisfaction of the trigger condition is based on the expected amount of data traffic. The operations of 1510 may be performed in accordance with examples as disclosed herein. In some examples, aspects of the operations of 1510 may be performed by an uplink message receiving manager 1030 as described with reference to FIG. 10.

At 1515, the method may include transmitting, in response to the uplink message, a downlink message indicating a resource allocated for communicating the expected amount of data traffic. The operations of 1515 may be performed in accordance with examples as disclosed herein. In some examples, aspects of the operations of 1515 may be performed by a downlink message transmitting manager 1035 as described with reference to FIG. 10.

At 1520, the method may include communicating at least a portion of the expected amount of data traffic with the UE via the indicated resource. The operations of 1520 may be performed in accordance with examples as disclosed herein. In some examples, aspects of the operations of 1520 may be performed by a UE communicating manager 1040 as described with reference to FIG. 10.

The following provides an overview of aspects of the present disclosure:

Aspect 1: A method for wireless communication at a UE, comprising: receiving, from a base station, control signaling indicating a proactive traffic reporting configuration identifying a trigger condition for proactively reporting expected data traffic for the UE; transmitting, to the base station based at least in part on a satisfaction of the trigger condition, an uplink message comprising an indication of an expected amount of data traffic for the UE, wherein the satisfaction of the trigger condition is based at least in part on the expected amount of data traffic; receiving, in response to the uplink message, a downlink message indicating a resource allocated for communicating the expected amount of data traffic; and communicating at least a portion of the expected amount of data traffic with the base station via the indicated resource.

Aspect 2: The method of aspect 1, further comprising: transmitting, to the base station and based at least in part on transmitting the uplink message, a second uplink message comprising an indication of a scheduled amount of data traffic for the UE, a buffered amount of data traffic for the UE, or both, wherein receiving the downlink message, communicating at least the portion of the expected amount of data traffic, or both, is based at least in part on the second uplink message.

Aspect 3: The method of aspect 2, further comprising: transmitting, via the second uplink message, an indication of a first difference between the expected amount of data traffic and the scheduled amount of data traffic, a second difference between the expected amount of data traffic and the buffered amount of data traffic, or both, wherein receiving the downlink message, communicating at least the portion of the expected amount of data traffic, or both, is based at least in part on the first difference, the second difference, or both.

Aspect 4: The method of any of aspects 1 through 3, further comprising: receiving, via the control signaling, an indication of a data threshold associated with the trigger condition for proactively reporting expected data traffic, wherein the satisfaction of the trigger condition is based at least in part on the expected amount of data traffic being greater than or equal to the data threshold.

Aspect 5: The method of any of aspects 1 through 4, further comprising: receiving, via the control signaling, an indication of a time threshold associated with the trigger condition for proactively reporting expected data traffic, wherein the satisfaction of the trigger condition is based at least in part on the expected amount of data traffic being expected within the time threshold.

Aspect 6: The method of any of aspects 1 through 5, further comprising: receiving, via the control signaling, an activation of the proactive traffic reporting configuration, wherein transmitting the uplink message is based at least in part on the activation of the proactive traffic reporting configuration.

Aspect 7: The method of any of aspects 1 through 6, further comprising: transmitting, via the uplink message, an expected time resource associated with the expected amount of data traffic, wherein the resource allocated for communicating the expected amount of data traffic is based at least in part on the expected time resource.

Aspect 8: The method of any of aspects 1 through 7, further comprising: transmitting, to the base station, a second uplink message comprising an indication of a second expected amount of data traffic for the UE, an indication of a change in the expected amount of data traffic for the UE, or both, wherein receiving the downlink message, communicating the portion of the expected amount of data traffic, or both, is based at least in part on the second uplink message.

Aspect 9: The method of any of aspects 1 through 8, further comprising: transmitting a scheduling request to the base station based at least in part on the satisfaction of the trigger condition; and receiving, from the base station in response to the scheduling request, an indication of a second resource for communicating the uplink message, wherein the uplink message is transmitted within the second resource.

Aspect 10: The method of any of aspects 1 through 9, further comprising: receiving, via the downlink message, an indication of an activated communications resource that has been activated in response to the expected amount of data traffic, wherein the portion of the expected amount of data traffic is communicated within the activated communications resource, and wherein the activated communications resource comprises an activated component carrier, an activated bandwidth part, an activated serving cell supported by the base station, or any combination thereof.

Aspect 11: The method of any of aspects 1 through 10, further comprising: receiving, via the downlink message, an indication to selectively adjust a quantity of communication layers used for communications at the UE, an indication to selectively adjust a HARQ process, or both, wherein communicating the portion of the expected amount of data traffic is based at least in part on the indication to selectively adjust a quantity of communication layers used for communications at the UE, the indication to selectively adjust the HARQ process, or both.

Aspect 12: The method of any of aspects 1 through 11, wherein the expected amount of data traffic comprises an expected amount of uplink data traffic for the UE, and the uplink message comprises a BSR message, a MAC-CE message, or both.

Aspect 13: The method of aspect 12, wherein the expected amount of data traffic is indicated via one or more LCID fields within the BSR message, within the MAC-CE message, or both, the one or more LCID fields are associated with proactively reporting expected data traffic for the UE.

Aspect 14: The method of any of aspects 1 through 13, wherein the expected amount of data traffic comprises an expected amount of downlink data traffic for the UE, and the uplink message comprises a message of a random access procedure, a UE assistance information message, or both.

Aspect 15: The method of any of aspects 1 through 14, wherein the expected amount of data traffic comprises an amount of data traffic which has not yet been scheduled for the UE, buffered by the UE, or both.

Aspect 16: A method for wireless communication at a base station, comprising: transmitting, to a UE, control signaling indicating a proactive traffic reporting configuration identifying a trigger condition for proactively reporting expected data traffic for the UE; receiving, from the UE based at least in part on a satisfaction of the trigger condition, an uplink message comprising an indication of an expected amount of data traffic for the UE, wherein the satisfaction of the trigger condition is based at least in part on the expected amount of data traffic; transmitting, in response to the uplink message, a downlink message indicating a resource allocated for communicating the expected amount of data traffic; and communicating at least a portion of the expected amount of data traffic with the UE via the indicated resource.

Aspect 17: The method of aspect 16, further comprising: receiving, from the UE and based at least in part on transmitting the uplink message, a second uplink message comprising an indication of a scheduled amount of data traffic for the UE, a buffered amount of data traffic for the UE, or both, wherein transmitting the downlink message, communicating at least the portion of the expected amount of data traffic, or both, is based at least in part on the second uplink message.

Aspect 18: The method of aspect 17, further comprising: receiving, via the second uplink message, an indication of a first difference between the expected amount of data traffic and the scheduled amount of data traffic, a second difference between the expected amount of data traffic and the buffered amount of data traffic, or both, wherein transmitting the downlink message, communicating at least the portion of the expected amount of data traffic, or both, is based at least in part on the first difference, the second difference, or both.

Aspect 19: The method of aspect 18, further comprising: transmitting, to the UE based at least in part on the first difference, the second difference, or both, a second downlink message indicating a deactivation of the proactive traffic reporting configuration.

Aspect 20: The method of any of aspects 16 through 19, further comprising: transmitting, via the control signaling, an indication of a data threshold associated with the trigger condition for proactively reporting expected data traffic, wherein the satisfaction of the trigger condition is based at least in part on the expected amount of data traffic being greater than or equal to the data threshold.

Aspect 21: The method of any of aspects 16 through 20, further comprising: transmitting, via the control signaling, an indication of a time threshold associated with the trigger condition for proactively reporting expected data traffic, wherein the satisfaction of the trigger condition is based at least in part on the expected amount of data traffic being expected within the time threshold.

Aspect 22: The method of any of aspects 16 through 21, further comprising: transmitting, via the control signaling, an activation of the proactive traffic reporting configuration, wherein receiving the uplink message is based at least in part on the activation of the proactive traffic reporting configuration.

Aspect 23: The method of aspect 22, further comprising: transmitting, via the control signaling, the activation of the proactive traffic reporting configuration based at least in part on an amount of data traffic for the base station satisfying a data traffic threshold.

Aspect 24: The method of any of aspects 16 through 23, further comprising: transmitting, to the UE, a second downlink message comprising a deactivation of the proactive traffic reporting configuration based at least in part on an amount of data traffic for the base station failing to satisfy a data traffic threshold.

Aspect 25: The method of any of aspects 16 through 24, further comprising: receiving, via the uplink message, an expected time resource associated with the expected amount of data traffic, wherein the resource allocated for communicating the expected amount of data traffic is based at least in part on the expected time resource.

Aspect 26: The method of any of aspects 16 through 25, further comprising: receiving, from the UE, a second uplink message comprising an indication of a second expected amount of data traffic for the UE, an indication of a change in the expected amount of data traffic for the UE, or both, wherein transmitting the downlink message, communicating the portion of the expected amount of data traffic, or both, is based at least in part on the second uplink message.

Aspect 27: The method of any of aspects 16 through 26, further comprising: receiving a scheduling request to the base station based at least in part on the satisfaction of the trigger condition; and transmitting, to the UE in response to the scheduling request, an indication of a second resource for communicating the uplink message, wherein the uplink message is received within the second resource.

Aspect 28: The method of any of aspects 16 through 27, further comprising: transmitting, via the downlink message, an indication of an activated communications resource that has been activated in response to the expected amount of data traffic, wherein the portion of the expected amount of data traffic is communicated within the activated communications resource, and wherein the activated communications resource comprises an activated component carrier, an activated bandwidth part, an activated serving cell supported by the base station, or any combination thereof.

Aspect 29: The method of any of aspects 16 through 28, further comprising: transmitting, via the downlink message, an indication to selectively adjust a quantity of communication layers used for communications at the UE, an indication to selectively adjust a HARQ process, or both, wherein communicating the portion of the expected amount of data traffic is based at least in part on the indication to selectively adjust a quantity of communication layers used for communications at the UE, the indication to selectively adjust the HARQ process, or both.

Aspect 30: The method of any of aspects 16 through 29, wherein the expected amount of data traffic comprises an expected amount of uplink data traffic for the UE, and the uplink message comprises a BSR message, a MAC-CE message, or both.

Aspect 31: The method of aspect 30, wherein the expected amount of data traffic is indicated via one or more LCID fields within the BSR message, within the MAC-CE message, or both, the one or more LCID fields are associated with proactively reporting expected data traffic for the UE.

Aspect 32: The method of any of aspects 16 through 31, wherein the expected amount of data traffic comprises an expected amount of downlink data traffic for the UE, and the uplink message comprises a message of a random access procedure, a UE assistance information message, or both.

Aspect 33: The method of any of aspects 16 through 32, wherein the expected amount of data traffic comprises an amount of data traffic which has not yet been scheduled for the UE, buffered by the UE, or both.

Aspect 34: An apparatus comprising a processor; memory coupled with the processor; and instructions stored in the memory and executable by the processor to cause the apparatus to perform a method of any of aspects 1 through 15.

Aspect 35: An apparatus comprising at least one means for performing a method of any of aspects 1 through 15.

Aspect 36: A non-transitory computer-readable medium storing code the code comprising instructions executable by a processor to perform a method of any of aspects 1 through 15.

Aspect 37: An apparatus comprising a processor; memory coupled with the processor; and instructions stored in the memory and executable by the processor to cause the apparatus to perform a method of any of aspects 16 through 33.

Aspect 38: An apparatus comprising at least one means for performing a method of any of aspects 16 through 33.

Aspect 39: A non-transitory computer-readable medium storing code the code comprising instructions executable by a processor to perform a method of any of aspects 16 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling indicating a proactive traffic reporting configuration identifying a trigger condition for proactively reporting expected data traffic for the UE;
transmitting, to the base station based at least in part on a satisfaction of the trigger condition, an uplink message comprising an indication of an expected amount of data traffic for the UE, wherein the satisfaction of the trigger condition is based at least in part on the expected amount of data traffic;
receiving, in response to the uplink message, a downlink message indicating a resource allocated for communicating the expected amount of data traffic; and
communicating at least a portion of the expected amount of data traffic with the base station via the indicated resource.

2. The method of claim 1, further comprising:
transmitting, to the base station and based at least in part on transmitting the uplink message, a second uplink message comprising an indication of a scheduled amount of data traffic for the UE, a buffered amount of data traffic for the UE, or both, wherein receiving the downlink message, communicating at least the portion of the expected amount of data traffic, or both, is based at least in part on the second uplink message.

3. The method of claim 2, further comprising:
transmitting, via the second uplink message, an indication of a first difference between the expected amount of data traffic and the scheduled amount of data traffic, a second difference between the expected amount of data traffic and the buffered amount of data traffic, or both, wherein receiving the downlink message, communicating at least the portion of the expected amount of data traffic, or both, is based at least in part on the first difference, the second difference, or both.

4. The method of claim 1, further comprising:
receiving, via the control signaling, an indication of a data threshold associated with the trigger condition for proactively reporting expected data traffic, wherein the satisfaction of the trigger condition is based at least in part on the expected amount of data traffic being greater than or equal to the data threshold.

5. The method of claim 1, further comprising:
receiving, via the control signaling, an indication of a time threshold associated with the trigger condition for proactively reporting expected data traffic, wherein the satisfaction of the trigger condition is based at least in part on the expected amount of data traffic being expected within the time threshold.

6. The method of claim 1, further comprising:
receiving, via the control signaling, an activation of the proactive traffic reporting configuration, wherein transmitting the uplink message is based at least in part on the activation of the proactive traffic reporting configuration.

7. The method of claim 1, further comprising:
transmitting, via the uplink message, an expected time resource associated with the expected amount of data traffic, wherein the resource allocated for communicating the expected amount of data traffic is based at least in part on the expected time resource.

8. The method of claim 1, further comprising:
transmitting, to the base station, a second uplink message comprising an indication of a second expected amount of data traffic for the UE, an indication of a change in the expected amount of data traffic for the UE, or both, wherein receiving the downlink message, communicating the portion of the expected amount of data traffic, or both, is based at least in part on the second uplink message.

9. The method of claim 1, further comprising:
transmitting a scheduling request to the base station based at least in part on the satisfaction of the trigger condition; and
receiving, from the base station in response to the scheduling request, an indication of a second resource for communicating the uplink message, wherein the uplink message is transmitted within the second resource.

10. The method of claim 1, further comprising:
receiving, via the downlink message, an indication of an activated communications resource that has been activated in response to the expected amount of data traffic, wherein the portion of the expected amount of data traffic is communicated within the activated communications resource, and wherein the activated communications resource comprises an activated component carrier, an activated bandwidth part, an activated serving cell supported by the base station, or any combination thereof.

11. The method of claim 1, further comprising:
receiving, via the downlink message, an indication to selectively adjust a quantity of communication layers used for communications at the UE, an indication to selectively adjust a hybrid automatic repeat request process, or both, wherein communicating the portion of the expected amount of data traffic is based at least in part on the indication to selectively adjust a quantity of communication layers used for communications at the UE, the indication to selectively adjust the hybrid automatic repeat request process, or both.

12. The method of claim 1, wherein the expected amount of data traffic comprises an expected amount of uplink data traffic for the UE, and wherein the uplink message comprises a buffer status report message, a medium access control-control element message, or both.

13. The method of claim 12, wherein the expected amount of data traffic is indicated via one or more logical channel identifier fields within the buffer status report message, within the medium access control-control element message, or both, wherein the one or more logical channel identifier fields are associated with proactively reporting expected data traffic for the UE.

14. The method of claim 1, wherein the expected amount of data traffic comprises an expected amount of downlink data traffic for the UE, and wherein the uplink message comprises a message of a random access procedure, a UE assistance information message, or both.

15. The method of claim 1, wherein the expected amount of data traffic comprises an amount of data traffic which has not yet been scheduled for the UE, buffered by the UE, or both.

16. A method for wireless communication at a base station, comprising:
transmitting, to a user equipment (UE), control signaling indicating a proactive traffic reporting configuration identifying a trigger condition for proactively reporting expected data traffic for the UE;
receiving, from the UE based at least in part on a satisfaction of the trigger condition, an uplink message comprising an indication of an expected amount of data traffic for the UE, wherein the satisfaction of the trigger condition is based at least in part on the expected amount of data traffic;
transmitting, in response to the uplink message, a downlink message indicating a resource allocated for communicating the expected amount of data traffic; and
communicating at least a portion of the expected amount of data traffic with the UE via the indicated resource.

17. The method of claim 16, further comprising:
receiving, from the UE and based at least in part on transmitting the uplink message, a second uplink message comprising an indication of a scheduled amount of data traffic for the UE, a buffered amount of data traffic for the UE, or both, wherein transmitting the downlink message, communicating at least the portion of the expected amount of data traffic, or both, is based at least in part on the second uplink message.

18. The method of claim 17, further comprising:
receiving, via the second uplink message, an indication of a first difference between the expected amount of data traffic and the scheduled amount of data traffic, a second difference between the expected amount of data traffic and the buffered amount of data traffic, or both, wherein transmitting the downlink message, communicating at least the portion of the expected amount of data traffic, or both, is based at least in part on the first difference, the second difference, or both.

19. The method of claim 18, further comprising:
transmitting, to the UE based at least in part on the first difference, the second difference, or both, a second downlink message indicating a deactivation of the proactive traffic reporting configuration.

20. The method of claim 16, further comprising:
transmitting, via the control signaling, an indication of a data threshold associated with the trigger condition for proactively reporting expected data traffic, wherein the satisfaction of the trigger condition is based at least in part on the expected amount of data traffic being greater than or equal to the data threshold.

21. The method of claim 16, further comprising:
transmitting, via the control signaling, an indication of a time threshold associated with the trigger condition for proactively reporting expected data traffic, wherein the satisfaction of the trigger condition is based at least in part on the expected amount of data traffic being expected within the time threshold.

22. The method of claim 16, further comprising:
transmitting, via the control signaling, an activation of the proactive traffic reporting configuration, wherein receiving the uplink message is based at least in part on the activation of the proactive traffic reporting configuration.

23. The method of claim 22, further comprising:
transmitting, via the control signaling, the activation of the proactive traffic reporting configuration based at least in part on an amount of data traffic for the base station satisfying a data traffic threshold.

24. The method of claim 16, further comprising:
transmitting, to the UE, a second downlink message comprising a deactivation of the proactive traffic reporting configuration based at least in part on an amount of data traffic for the base station failing to satisfy a data traffic threshold.

25. The method of claim 16, further comprising:
receiving, via the uplink message, an expected time resource associated with the expected amount of data traffic, wherein the resource allocated for communicating the expected amount of data traffic is based at least in part on the expected time resource.

26. The method of claim 16, further comprising:
receiving, from the UE, a second uplink message comprising an indication of a second expected amount of data traffic for the UE, an indication of a change in the expected amount of data traffic for the UE, or both, wherein transmitting the downlink message, communicating the portion of the expected amount of data traffic, or both, is based at least in part on the second uplink message.

27. The method of claim 16, further comprising:
receiving a scheduling request to the base station based at least in part on the satisfaction of the trigger condition; and
transmitting, to the UE in response to the scheduling request, an indication of a second resource for communicating the uplink message, wherein the uplink message is received within the second resource.

28. The method of claim 16, further comprising:
transmitting, via the downlink message, an indication of an activated communications resource that has been activated in response to the expected amount of data traffic, wherein the portion of the expected amount of data traffic is communicated within the activated communications resource, and wherein the activated communications resource comprises an activated component carrier, an activated bandwidth part, an activated serving cell supported by the base station, or any combination thereof.

29. An apparatus for a user equipment (UE), comprising:
a processor;
memory coupled with the processor; and
instructions stored in the memory and executable by the processor to cause the apparatus to:
receive, from a base station, control signaling indicating a proactive traffic reporting configuration identifying a trigger condition for proactively reporting expected data traffic for the UE;
transmit, to the base station based at least in part on a satisfaction of the trigger condition, an uplink message comprising an indication of an expected amount of data traffic for the UE, wherein the satisfaction of the trigger condition is based at least in part on the expected amount of data traffic;
receive, in response to the uplink message, a downlink message indicating a resource allocated for communicating the expected amount of data traffic; and
communicate at least a portion of the expected amount of data traffic with the base station via the indicated resource.

30. An apparatus, comprising:
a processor;
memory coupled with the processor; and
instructions stored in the memory and executable by the processor to cause the apparatus to:
transmit, to a user equipment (UE), control signaling indicating a proactive traffic reporting configuration identifying a trigger condition for proactively reporting expected data traffic for the UE;
receive, from the UE based at least in part on a satisfaction of the trigger condition, an uplink message comprising an indication of an expected amount of data traffic for the UE, wherein the satisfaction of the trigger condition is based at least in part on the expected amount of data traffic;
transmit, in response to the uplink message, a downlink message indicating a resource allocated for communicating the expected amount of data traffic; and
communicate at least a portion of the expected amount of data traffic with the UE via the indicated resource.
